(19) United States
(12) Patent Application Publication
(10) Pub. No.: US 2026/0148064 A1
(43) Pub. Date: May 28, 2026

(54) Systems and Methods for Unlearning

(71) Applicants: Northeastern University, Boston, MA (US); The Government of the United States, as represented by the Secretary of the Army, West Point, NY (US)

(72) Inventors: Francesco Restuccia, Boston, MA (US); Nathaniel D. Bastian, Chester, NY (US); A Q M Sazzad Sayyed, Quincy, MA (US)

(21) Appl. No.: 19/402,551

(22) Filed: Nov. 26, 2025

Related U.S. Application Data
(60) Provisional application No. 63/725,431, filed on Nov. 26, 2024.

(51) Int. Cl. G06N 3/08; G06N 3/0455

(52) U.S. Cl. CPC G06N 3/08; G06N 3/0455

(57) ABSTRACT

Embodiments perform unlearning. An embodiment obtains (i) a machine learning (ML) model trained on multiple classes of data and (ii) a dataset representing a target class, of the multiple classes, to be unlearned from the obtained ML model. An instance of the obtained MIL model is saved as a target model. Iteratively, until a criterion is met: (1) the obtained ML model is used to generate an output based on a subset of the obtained dataset; (2) the generated output is processed to determine at least one of an energy loss metric and a knowledge distillation (KD) loss metric; and (3) the target model is transformed into an unlearned ML model based on at least one of the energy loss metric and the KD loss metric.

### RELATED APPLICATION

This application claims the benefit of U.S. Provisional Application No. 63/725,431, filed on Nov. 26, 2024. The entire teachings of the above Application are incorporated herein by reference.

### GOVERNMENT SUPPORT

This invention was made with government support under Grant Number CNS-2312875 awarded by the National Science Foundation, under Grant Number N00014-23-1-2221 awarded by the Office of Naval Research, and under Grant Number FA9550-23-1-0261 awarded by the U.S. Air Force Office of Scientific Research. The government has certain rights in the invention.

### Incorporation by Reference of Material in Ascii Files

This Application incorporates by reference the Computer Program Listing contained in the following ASCII files being submitted concurrently herewith:
a) File name: create_mask_from_gradients.txt; created Nov. 26, 2025, 1,681 Bytes in size.
b) File name: add gaussian_noise.txt; created Nov. 26, 2025, 904 Bytes in size.
c) File name: add_salt_and_pepper_noise_batch.txt; created Nov. 26, 2025, 892 Bytes in size.
d) File name: ood_assisted_unlearning.txt; created Nov. 26, 2025, 1,382 Bytes in size.
e) File name: ood_unlearning.txt; created Nov. 26, 2025, 431 Bytes in size.

### BACKGROUND

Machine unlearning includes removing unwanted information from (e.g., from being considered by) a trained machine learning model without needing to rebuild or retrain the entire model. Non-limiting examples of unwanted information include private or personal data, inaccurate or contaminated training data, outdated information, copyrighted or proprietary material, harmful content, dangerous capabilities, unused content, and misinformation. Class-level machine unlearning includes removing information for an entire category or class of data, instead of individual data items, from a trained model.

### SUMMARY

Problematically, many existing machine unlearning approaches are limited by their reliance on a “retain” dataset, i.e., a sub-dataset containing knowledge to be maintained after unlearning. In some such existing approaches, the “retain” dataset may be a portion of the dataset used to train the model. Conventional approaches also exhibit low performance or have excessive computation and/or storage requirements. Such drawbacks make traditional approaches inapplicable in mobile or edge computing scenarios, where computation and memory are severely constrained, yet unlearning may often need to be performed frequently and effectively. Thus, functionality with improved performance, efficiency, speed, and reliability is needed. Embodiments provide such functionality.

An example embodiment removes knowledge about a given class of data (called a “forget” class) from a pretrained machine learning (ML) model, e.g., a deep neural network (DNN). Another example embodiment modifies a ML model so that the model identifies or views samples of a forget class as out-of-distribution (OOD) samples—e.g., samples that have not been used for training the model.

Conventional machine unlearning approaches include rearranging a decision space of a ML model to shrink the decision space of corresponding forget samples. In contrast with traditional approaches, example embodiments, which may be referred to herein as “Class-Label Unlearning for Efficiency” (CLUE), are more efficient and less computationally demanding.

An example embodiment is directed to a computer-based system for unlearning. The system includes at least one processor and a memory with computer code instructions stored or held thereon. The at least one processor and the memory, with the computer code instructions, are configured to cause the system to obtain (i) a ML model trained on multiple classes of data and (ii) a dataset representing a target class, of the multiple classes, to be unlearned from the obtained ML model. The at least one processor and the memory, with the computer code instructions, are further configured to cause the system to save an instance of the obtained ML model as a target model. The at least one processor and the memory, with the computer code instructions, are further configured to cause the system to, iteratively, until a criterion is met: (1) use the obtained ML model to generate an output based on a subset of the obtained dataset; (2) process the generated output to determine at least one of an energy loss metric and a knowledge distillation (KD) loss metric; and (3) transform the target model into an unlearned ML model based on at least one of the energy loss metric and the KD loss metric.

In an example embodiment, in processing the generated output, the at least one processor and the memory, with the computer code instructions, may be configured to cause the system to determine the energy loss metric using a Helmholtz free energy (HFE) partition function, the subset of the obtained dataset, and the generated output.

According to an example embodiment, in using the obtained ML model to generate the output, the at least one processor and the memory, with the computer code instructions, may be configured to cause the system to transform the subset of the obtained dataset into out-of-distribution (OOD) data using a noise distribution. The at least one processor and the memory, with the computer code instructions, may be further configured to cause the system to, using the obtained ML model, generate a reference output based on the OOD data. The at least one processor and the memory, with the computer code instructions, may be further configured to cause the system to, using the target model, generate a target output based on the subset of the obtained dataset. In one such embodiment, in processing the generated output, the at least one processor and the memory, with the computer code instructions, may be configured to cause the system to determine the KD loss metric based on the subset of the obtained dataset, the generated reference output, and the generated target output. According to another such embodiment, in determining the KD loss metric, the at least one processor and the memory, with the computer code instructions, may be configured to cause the system to determine Kullback-Leibler (KL) divergence based on the subset of the obtained dataset, the generated reference output, and the generated target output. In yet another such embodiment, the noise distribution may be a Gaussian distribution or a Bernoulli distribution.

In an example embodiment, the at least one processor and the memory, with the computer code instructions, may be further configured to cause the system to generate a gradient mask using the obtained ML model and the obtained dataset. The at least one processor and the memory, with the computer code instructions, may be further configured to cause the system to transform the target model into the unlearned ML model based on the generated gradient mask and at least one of the energy loss metric and the KD loss metric. According to one such embodiment, in generating the gradient mask, the at least one processor and the memory, with the computer code instructions, may be configured to cause the system to determine a cross-entropy metric using the obtained ML model and the obtained dataset. The at least one processor and the memory, with the computer code instructions, may be further configured to cause the system to determine an importance value of a parameter of the obtained ML model based on a value of the parameter and the determined cross-entropy metric. The at least one processor and the memory, with the computer code instructions, may be further configured to cause the system to determine a mask value of the gradient mask based on comparing the determined importance value to a threshold value.

According to an example embodiment, in transforming the target model into the unlearned ML model, the at least one processor and the memory, with the computer code instructions, may be configured to cause the system to determine an unlearning loss metric based on a weighting value and both the energy loss metric and the KD loss metric. The at least one processor and the memory, with the computer code instructions, may be further configured to cause the system to transform the target model into the unlearned ML model based on the determined unlearning loss metric.

In an example embodiment, in transforming the target model into the unlearned ML model, the at least one processor and the memory, with the computer code instructions, may be configured to cause the system to transform the target model into the unlearned ML model based on a learning rate value and at least one of the energy loss metric and the KD loss metric.

According to an example embodiment, the criterion may be a number of epochs.

In an example embodiment, the system may be implemented at least in part in a mobile or edge device.

According to an example embodiment, the obtained ML model may be a neural network model.

In an example embodiment, the target class may be an outdated object class, a facial recognition class, or a malicious class, among other examples.

Another example embodiment is directed to a computer-implemented method of unlearning. The method is configured to implement any embodiments or combination of embodiments described herein.

Yet another embodiment is directed to a computer program product for unlearning. The computer program product includes a non-transitory computer-readable medium with computer code instructions stored thereon. The computer code instructions are configured, when executed by a processor, to cause an apparatus associated with the processor to implement any embodiments or combination of embodiments described herein.

It is noted that embodiments of the system, method, and computer program product may be configured to implement any embodiments or combination of embodiments described herein.

### BRIEF DESCRIPTION OF THE DRAWINGS

The patent or Application file contains at least one drawing executed in color. Copies of this patent or patent Application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a block diagram of an example framework for unlearning according to an embodiment.

FIG. 2 shows run time efficiency results for unlearning, including results for an example embodiment.

FIGS. 3A-3C visualize an example decision space according to an embodiment.

FIG. 4 depicts example distributions of Helmholtz free energy (HFE) before and after unlearning according to an embodiment.

FIG. 5 depicts example distributions of HFE before and after unlearning according to another embodiment.

FIG. 6 illustrates original images and example attention maps according to an embodiment.

FIG. 7 illustrates an example setup for power and latency measurement according to an embodiment.

FIGS. 8A and 8B illustrate example latency and energy comparisons, respectively, according to an embodiment.

FIGS. 9A and 9B are graphs of samples with label changes after unlearning and samples that are corrected after unlearning, respectively, according to an embodiment.

FIGS. 10A-10C illustrate original images and example attention maps according to another embodiment.

FIG. 11 is a flowchart of a method of unlearning according to an example embodiment.

FIG. 12 is a schematic view of a computer network in which embodiments may be implemented.

FIG. 13 is a block diagram illustrating an example embodiment of a computer node in the computer network of FIG. 12.

### DETAILED DESCRIPTION

A description of example embodiments follows.

Class-level machine unlearning (CMU) has been proposed to address security and privacy challenges with machine learning (ML) models, e.g., deep neural networks (DNNs). However, existing machine unlearning approaches either exhibit low performance or have excessive computation and/or storage requirements. This makes the existing approaches inapplicable in mobile computing scenarios, where computation and memory are severely constrained, yet unlearning must often be performed frequently and effectively. Further, existing machine unlearning approaches are limited by their reliance on a “retain” dataset, i.e., a sub-dataset (portion of the training data) containing the knowledge that should be maintained after the unlearning. In contrast, embodiments provide unlearning techniques that do not require a retain dataset. An example embodiment treats inputs coming from a “forget” class as out-of-distribution (OOD) data and uses knowledge distillation (KD) to impose this constraint on an updated ML model. An example embodiment was experimentally evaluated on both the ResNet20 deep learning architecture and the vision transformer (ViT) architectures ViT-Base and ViT-Large trained on the CIFAR10, CIFAR100, and VGGFace2 datasets. An example embodiment was also implemented on Raspberry Pi and its power consumption and latency were compared to several existing baselines.

Example embodiments improve power consumption by 68% and latency by 90% while improving unlearning performance by up to 4.74%.

Certain embodiments offer novel class-level unlearning techniques for mobile devices that modify a ML model (e.g., DNN) to process forget class samples as OOD, without requiring access to a retain dataset. Experiments across multiple architectures and a real-world edge device show that embodiments improve power consumption, latency, and unlearning performance over existing baselines. Embodiments have applications to the field of data-free unlearning—i.e., unlearning that does not require access to original training data or a retain set—and may potentially be utilized for tasks such as object detection with images and semantic segmentation.

### INTRODUCTION

Addressing security and privacy concerns of ML models helps to guarantee continued acceptance of artificial intelligence (AI) by the broader public. Indeed, as companies collect user data to improve their ML models, attacks based on, e.g., membership inference and model inversion, can lead to identity theft and misuse of sensitive personal data.

To protect user privacy, existing laws such as the California Consumer Privacy Act (CCPA) in the U.S. and the General Data Protection Regulation (GDPR) in the EU require companies to delete the data of individual consumers on request, also known as the “right to be forgotten.” An increased awareness of user privacy issues has led to the emergence of machine unlearning, which seeks to remove the influence of a subset of a ML model's training data without requiring complete retraining of the model. For instance, machine unlearning can be used to suppress a subset of training data that is identified as corrupted or poisoned (item removal), remove specific features (feature removal), remove an entire class (class removal), and forget specific tasks (task removal).

Certain embodiments provide techniques for CMU. An example application of CMU is continual learning in constrained mobile systems, where a ML model may be required to forget outdated object classes, thereby removing irrelevant knowledge and making room for new tasks to adapt to new environments. In addition to mobile systems, other example applications of CMU include removing facial recognition or identification, defending against backdoor attacks, and eliminating or purging malicious classes. Removing classes in real time on mobile devices also enables numerous real-world applications. As one example, in smart home scenarios where cameras are used to identify household members, a particular face may need to be removed while still recognizing other household members. For instance, parents may invoke the Children's Online Privacy Protection Act (COPPA) to immediately delete a minor's data. Another example is sensors deployed for wildlife monitoring, where environmental regulations and/or conservation policies often mandate discarding images of endangered species after rapid annotation while minimizing bandwidth.

The above example scenarios demonstrate that the ability to jettison a class quickly—for instance, when operating entirely within the confines of a mobile device—and without access to a retain set can support many real-world applications. In these scenarios, unlearning may need to be performed not as a scheduled or periodic maintenance task, but instead as fast as possible and with as low resource consumption as possible. As explained in further detail hereinbelow, existing approaches are mainly limited to applications where unlearning is performed on devices that are not constrained by their computation and memory resources. As such, existing approaches rely on access to a retain dataset, which is an original dataset minus data to be unlearned. However, using a retain set increases the complexity and energy consumption of an unlearning process. Relying on a retain set is also unrealistic, because in practice, access to such data may be restricted or unavailable. Many real-world ML model deployments discard training data due to privacy laws (e.g., GDPR) or operational policies based on industry requirements (e.g., healthcare, defense, etc.). In such cases, the retain set is no longer available. This is especially true for pretrained models, where the original training data is not accessible. Fetching or storing a retain set again may also be infeasible or undesirable on embedded systems, which may be required to support on-device unlearning in data-sparse, privacy-sensitive, and/or offline environments.

### Limitations of Existing Approaches

The first machine unlearning approach was published in 2015 and included decomposing a ML model into a series of sums and eliminating a portion of sum operations that are affected by a forget class. Later approaches focused on the topic of exact unlearning, which is a process of completely removing certain data so that performance is exactly the same as retraining a model without the data to be unlearned. However, these approaches cannot be applied to models such as DNNs due to a non-convex nature of an objective function.

The first exact unlearning framework for DNNs was Sharded, Isolated, Sliced, and Aggregated (SISA) training, which divides a dataset into multiple slices to create an ensemble of DNNs and uses majority voting for inference. This requires only the DNNs trained on slices containing samples of a forget dataset to be retrained. However, another approach highlighted SISA's limitations with class imbalance. A framework building on SISA has provable differential privacy guarantees when unlearning requests arrive in streams. Although other approaches have attempted certifiable unlearning, the other approaches often rely on strong assumptions about a learning approach and lack evaluation on standard benchmark datasets. This line of research has helped establish a foundation for certifiable unlearning with provable guarantees, particularly in privacy-preserving applications. Yet, for broader scenarios-such as defending against backdoor attacks, enhancing lifelong learning, or improving fairness in DNNs-more practical approaches have emerged. For instance, one approach employed the Fisher information matrix (FIM) to identify critical weights for unlearning. Recently, an approach was developed where knowledge of data to be forgotten is distilled from a randomly initialized teacher model, while another approach addressed unlearning for both classification and image generation tasks. To accelerate the unlearning process, an incremental approach was introduced that adjusts parameters based on removal of specific data points without a full update. The data points are removed by fine-tuning a model on noise samples generated by maximizing loss for a forget dataset. All the above existing approaches rely on access to a retain dataset.

Some existing approaches for machine unlearning do not access a retain dataset. While one approach does not require storing an entire retain dataset but only its FIM, the computational complexity of this existing approach scales cubically with a number of parameters in a model because it needs to obtain the FIM. Another approach tried to overcome this issue by approximating only a diagonal of a FIM. While one research group tried to align an output of a model to that of an OOD input, their approach is based on minimizing a Lipschitz constant of the model, which is orthogonal to the approach employed by an example embodiment. Another research group introduced Boundary Shrinking (BS) and Boundary Expanding (BE). BS relabels data points of a forget dataset with a nearest neighbor class label and fine-tunes a model with a resulting forget dataset. BE adds an extra class and assigns data points of a forget class to that extra class. Then, after fine-tuning, the extra node is removed. However, this research group uses small datasets (e.g., CIFAR10 and 10 randomly sampled classes from VGGFace2) and its approach is evaluated on outdated architectures (e.g., VGG, AllCNN).

Other existing approaches employ subspace-based unlearning. One such existing approach is training-free in that it directly identifies and removes low-dimensional subspaces associated with a forget set, efficiently eliminating knowledge without retraining. However, this existing approach relies on clean subspace separation and, thus, has limited effectiveness when forget and retain knowledge are entangled. Another approach leverages null-space constraints calibrated to retain data, suppressing forget-set knowledge while reducing over-unlearning, but it requires reliable pseudo-labeling and access to retain data. Yet another approach employs a sparse autoencoder to decompose hidden representations into relevant and irrelevant subspaces, projecting forget-set gradients into the latter to improve the forget-retain trade-off, at the cost of additional overhead.

Beyond these existing approaches, recent approaches include zero-shot unlearning, which removes knowledge without access to explicit forget data. Examples of zero-shot unlearning strategies include iterative null-space projection for concept erasure, direct parameter editing to overwrite or nullify specific facts, and noise generation for selectively damaging information about a forget class. These strategies highlight the growing interest in efficient, data-free unlearning, but they often incur tradeoffs between performance of forgetting and preservation of retained knowledge.

In contrast, embodiments provide efficient techniques for unlearning that do not require a retain dataset, yet outperform existing approaches. An example embodiment may leverage the insight that, because OOD inputs are drawn from a distribution different than a training distribution, a ML model can be modified so that inputs coming from a target class to be unlearned (which constitute a forget set) will be treated as OOD. This reconceptualization of class unlearning is a novel benefit of embodiments that is lacking in existing approaches. Further, to perform class unlearning, as explained in further detail herein, an example embodiment may use a unique and innovative combination of an energy-based loss function, KD, and gradient masking.

Example embodiments were extensively benchmarked on both ResNet20 and ViT models, such as ViT-Base and ViT-Large, trained on CIFAR10, CIFAR100, and VGGFace2 datasets. Performance of the example embodiments was characterized on Raspberry Pi 5 and power consumption and latency of embodiments were compared with respect to several existing baselines. Results from the benchmarking show that example embodiments deliver improvements of up to 68%, 90%, and 4.74% in terms of power consumption, latency, and unlearning performance, respectively—i.e., the difference in average performance compared to an existing “retrain from scratch” approach—while requiring up to 30% less memory than conventional approaches. When evaluated against a traditional approach, example embodiments achieve an average relative improvement of 27.28% in unlearning performance (the performance improvement averaged across all metrics), with gains as high as 70% on the ViT-Base architecture with the CIFAR10 dataset. These results demonstrate that example embodiments substantially outperform conventional approaches in both efficacy and efficiency, in a setting where data access is constrained due to an inability to access a retain set.

### Preliminary Concepts

### Example Class-Level Machine Unlearning

An example embodiment may perform CMU in the context of supervised learning. In an embodiment, a ML model (e.g., DNN) may be denoted by [symbol] _{θ}, where θ is a set of parameters. A learning procedure may be defined as [symbol] : θ×D→θ*, which maps a dataset D and model parameters θ to a set of parameters θ* optimized for a corresponding dataset. The dataset D may include N input-label pairs

$${\{ {x}_{i} , {y}_{i} \}}_{i = 1}^{i = N}$$

sampled from the space [symbol] × [symbol] which follows distribution [symbol] ₜᵣₐᵢₙ. In the sampling space, [symbol] may denote an input space and [symbol] ={1, 2, . . . , K} may represent a label space. A forget dataset may be denoted with Dᵣ so that a retain dataset is Dᵣ=D\Dᵣ. By taking D_{f} as including a single class, a forget class c_{f}∈ [symbol] may also be defined as a class to be unlearned. Given an input xᵢ, vector zᵢ= [symbol] _{θ*} (xᵢ) may represent logits of the model.

An example embodiment may remove information related to the forget dataset with D_{f} from the trained model [symbol] _{θ*} . without retraining from scratch, without accessing the retain dataset Dᵣ, and without significantly affecting performance on Dᵣ. In an embodiment, parameters of a ML model retrained only on a retain set may be denoted by θ^{r} and an unlearning procedure may be defined as [symbol] (θ*, D_{f}). The goal of the unlearning procedure may be to map θ* to another set of parameters ef. Due to a stochastic nature of training a ML model, Or may be different for different training configurations or weight initializations—even for the same model performance—thus forming a distribution for a given dataset. As a result, exact unlearning may be defined as a case in which Of comes from the same distribution as θ^{r}. Approximate unlearning may be defined as a case in which d( [symbol] _{θ}_{^{f}}(x), [symbol] _{θ}_{^{r}}(x))≃0, where d(·) is a suitable distance metric.

### Example OOD Detection

In an embodiment, taking training data as following distribution Dₜᵣₐᵢₙ, an OOD sample may be defined as an input-label pair {xᵢ, yᵢ} that does not follow Dₜᵣₐᵢₙ. The following are example scenarios where an OOD sample is present:
a) Label yᵢ∉ [symbol] , meaning the class yᵢ does not belong to the label space y and thus a shift in semantic content of the input xᵢ has happened, e.g., emergence of a novel class.
   i. This scenario is also known as semantic OOD, which indirectly entails a change in input distribution D [symbol] .
b) Label yᵢ∈ [symbol] and xᵢ∉ [symbol] , meaning a distribution of the input x; does not follow the training distribution Dₜᵣₐᵢₙ.
   i. This is also known as covariate-shifted OOD or non-semantic OOD.

### Example Energy Function for OOD Detection

In an embodiment, an energy function may be utilized for OOD input detection. For instance, an example embodiment may leverage the insight that probability p(x)—which represents a likelihood that x is an In-Distribution (ID) input-will have a low value for an OOD input. An example embodiment may also capitalize on the similarity between the formulation of the softmax probability of a ML model (e.g., DNN) and the Gibbs distribution. Some existing approaches rely on a softmax confidence score to safeguard against OOD inputs. This is suboptimal, however, because the softmax posterior distribution can have a label-overfitted output space. As a superior alternative, a collection of energy values corresponding to each point x in an input space can be turned into the probability density p(x) via the Gibbs distribution. Specifically, it has been shown that the log probability of the input log p(x) is affinely related to Helmholtz free energy (HFE)—i.e., the former can be transformed into the latter by a linear transformation and a translation. According to an embodiment, HFE may be defined by example Equation (1) below as:

$$E ( x ; {ℱ}_{θ} ) = - T \cdot log ( {\sum }_{{y}_{i}} {e}^{{ℱ}_{θ}^{{y}_{i}} ( x ) / T} ) \qquad ( 1 )$$

where

$${\sum }_{{y}_{i}} {e}^{{ℱ}_{{θ}^{*}}^{{y}_{i}} ( {x}_{i} ) / T}$$

is termed a partition function.

According to an embodiment, a value of T=1 may be used for example Equation (1) above. Other known values of T, e.g., non-zero positive values, are also suitable.

In an embodiment, HFE can be used to characterize OOD samples, because ID samples usually have lower HFE than the OOD samples. As explained in more detail hereinbelow, an example embodiment may employ these contrasting HFE values as a proxy for an approximate unlearning outcome.

A method for OOD detection may be as described in Liu et al., “Energy-based out-of-distribution detection,” Advances in neural information processing systems 33 (2020): 21464-21475, which is herein incorporated by reference in its entirety.

### Overview of Example Embodiments

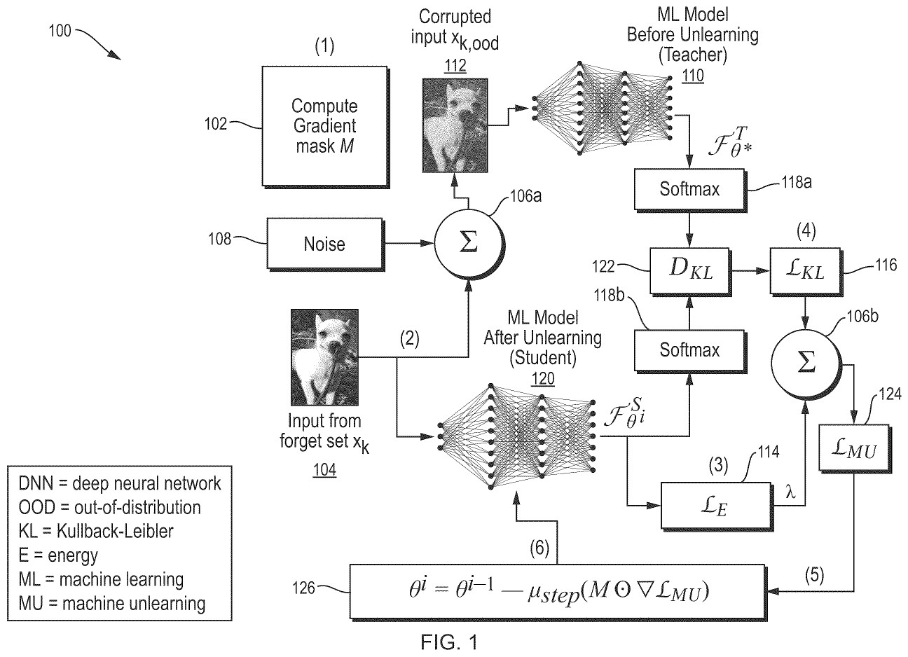

FIG. 1 is a block diagram of an example framework 100 for unlearning according to an embodiment. As shown in FIG. 1, the framework 100 may include:
a) an energy loss function [symbol] _{E} 114 that leverages HFE for OOD sample detection;
b) a KD loss function [symbol] _{KL} 116; and
c) a gradient masking process 126 that excludes gradients while unlearning with a mask M 102, which is constructed based on weight salience of a forget dataset.

Continuing with FIG. 1, both “teacher” 110 and “student” 120 ML models (e.g., [0066] DNNs) are initialized with [symbol] ₀*. Step (1) includes computing the gradient mask M 102 for a forget dataset (not shown) using

$${F}_{{θ}^{i}}^{S}$$

at upuate step r. INext, Step (2) includes feeding a batch of samples 104 from the forget dataset to the student model 120, as well as combining 106a (e.g., summing) noise 108 (e.g., Gaussian noise) with the samples 104 to generate corresponding corrupted samples 112, which are then fed to the teacher model 110. Step (3) includes computing the energy loss [symbol] _{E} 114 for the student model

$${ℱ}_{{θ}^{i}}^{S}$$

120. In turn, Step (4) includes computing the KD loss [symbol] _{KL} 116 using outputs of both the teacher 110 and student 120 models. According to an embodiment, a softmax function 118a and 118b may be applied to the teacher 110 and student 120 outputs, respectively, after which Kullback-Leibler (KL) divergence 122 is computed. The KL divergence 122 may then be used to compute the KD loss 116. Step (5) includes combining 106b the energy 114 and KD 116 losses to determine total machine unlearning (MU) loss LMU 124. Finally, Step (6) includes updating θⁱ 126.

Continuing with FIG. 1, in an embodiment, after E unlearning iterations,

$${ℱ}_{{θ}_{E}}^{S}$$

resulting from the student model 120 may become a final unlearned model

$${ℱ}_{{θ}_{f}}^{S}$$

It is noted that in an example implementation of Step (3), computing the energy loss [symbol] _{E} 114 for the student model

$${ℱ}_{{θ}^{i}}^{S}$$

120, may be omitted and, instead, the KD loss [symbol] _{KL} 116 may be considered the total MU loss [symbol] _{MU} 124. Further, in yet another implementation, only energy loss [symbol] _{E} 114 may be determined and, thus, the energy loss [symbol] _{E} 114 may be considered the total MU loss [symbol] _{MU} 124.

It is further noted that in another example implementation of the framework 100, Step (1) may be omitted, and Step (6) may be performed without using a mask to exclude gradients in the update process 126.

### Example Energy Loss

In an embodiment, an exact unlearning procedure [symbol] may map optimized parameters of a ML model [symbol] _{θ*} (e.g., DNN) into θ^{r}. Because exact unlearning may not always be feasible or desirable in a given scenario, an example embodiment may instead employ an approximate unlearning procedure. An example embodiment may match an output of an unlearned ML model [symbol] _{θ}_{^{f}} to that of a ML model [symbol] _{θ}_{^{r}} trained on a retain dataset only. However, the model [symbol] _{θ}_{^{r}} may not be available due to lack of access to the retain set. An example embodiment may thus leverage the insight that, after unlearning a particular class c_{f}∈ [symbol] , samples from a forget dataset D_{f} may behave the same as any other OOD samples. In an embodiment, an energy loss function [symbol] _{E} in example Equation (2) below may accordingly be designed to make the samples from the forget dataset D_{f} behave like OOD samples for an updated model:

$${ℒ}_{E} = \frac{1}{\vert {D}_{f} \vert} {\sum }_{{x}_{k} ∈ {D}_{f}} {\sum }_{{y}_{i}} {e}^{{ℱ}_{{θ}^{*}}^{{y}_{i}} ( {x}_{i} / T )} \qquad ( 2 )$$

where |D_{f}| denotes the cardinality of the forget dataset.

From example Equation (1) (described hereinabove), an example embodiment may recognize that OOD samples have higher HFE than ID samples. In other words, the OOD samples may have lower values of the partition function in example Equation (2) above, which is given by

$${\sum }_{{y}_{i}} {e}^{{ℱ}_{{θ}^{*}}^{{y}_{i}} ( {x}_{i} ) / T} .$$

Thus, in an embodiment, the forget dataset can be approximated as OOD data by minimizing this partition function for the forget dataset D_{f}.

### Example KD Loss

While energy loss can induce OOD behavior on a forget dataset, it does not provide any direct guidance regarding a posterior probability of a ML model (e.g., DNN). This may adversely affect retain classes as shown in more detail hereinbelow. Such an adverse effect may result from an unguided change in a logit distribution of the retain classes during unlearning. To introduce guidance that makes updates of a ML model smoother, an example embodiment may employ KD techniques by designating a ML model before and after unlearning as a teacher and student model, respectively. In an embodiment, using KD loss may provide an unlearned/student model with information about a retain set embedded in logits while aligning a representation of an unlearn class with that of heavily corrupted OOD-like inputs. This may in turn counteract any abrupt change in the logit space introduced by using energy loss. In an embodiment, parameters of a student model at an i-th iteration may be defined as θⁱ, where θ⁰=θ*. According to an embodiment, a KD loss function [symbol] _{KL} can be written as in example Equation (3) below:

$${ℒ}_{KL} = \frac{{\sum }_{{x}_{i} ∈ {D}_{f}} {D}_{KL} ( {σ}_{s} ( {ℱ}_{{θ}^{*}}^{T} ( {x}_{i , ood} ) ) , {σ}_{s} ( {ℱ}_{{θ}^{i}}^{S} ( {x}_{i} ) ) )}{\vert {D}_{f} \vert} \qquad ( 3 )$$

where σₛ denotes softmax activation, D_{KL} denotes KL divergence, and x_{i,ood} denotes a corrupted version of input xᵢ.

In an embodiment, the variable x_{i,ood} may be obtained with example Equation (4) below:

$${x}_{i , ood} = {x}_{i} + n ; n \sim 𝒫 \qquad ( 4 )$$

In example Equation (4) above, [symbol] may denote a noise distribution, e.g., a Gaussian distribution [symbol] (μ, σ²) or a bimodal Bernoulli distribution [symbol] (pₛ, pₚ) for salt-and-pepper noise with respective probabilities of salt and pepper noise pₛ and pₚ. Other known distributions are also suitable. An example embodiment may leverage the insight that, for a sufficiently high noise power σ² (when using a Gaussian distribution) applied to an input xᵢ, a resulting corrupted input x_{i,ood} may resemble an OOD sample. In an embodiment, this phenomenon may cause a student model to align its posterior distribution with a posterior of a teacher model

$${ℱ}_{{θ}^{*}}^{T}$$

fed with OOD data. Although [symbol] _{θ}_{^{r}} may be an ideal teacher model, an example embodiment may approximate the posterior [symbol] _{θ}_{^{r}} with that of [symbol] _{θ}*, to overcome lack of access to the former. In an embodiment, minimizing KD loss can help a student model learn a posterior distribution of OOD data-which is not possible with energy loss alone. According to an embodiment, the two loss functions [symbol] _{E} and [symbol] _{KL} may be combined to arrive at a total machine unlearning (MU) loss function [symbol] _{MU} as given below in example Equation (5), where λ is a hyperparameter that establishes a relative contribution of the two loss functions.

$${L}_{MU} = {L}_{KL} + λ \cdot {L}_{E} \qquad ( 5 )$$

### Example Gradient Masking

When performing approximate unlearning, it may be desirable to preserve accuracy on a retain dataset. To achieve this, an example embodiment may utilize an interpretability-based technique—e.g., a technique that considers how a ML model reaches a particular output for a given input. For example, in an embodiment, a gradient mask M may be created based on saliency of weights of a forget dataset. To determine the saliency of the weights, an example embodiment may employ an importance estimation technique. In an embodiment, importance R of a weight w may be measured as shown in a lefthand portion of example Equation (6) below:

$$R ( w ) = \vert w \frac{\partial {ℒ}_{CE}}{\partial w} \vert ; M = 𝕝 ( R ( w ) > τ ) \qquad ( 6 )$$

where [symbol] _{CE} denotes cross-entropy (CE) loss of a ML model for the forget dataset.

A method for importance estimation may be as described in Molchanov et al., “Pruning convolutional neural networks for resource efficient inference,” arXiv preprint arXiv: 1611.06440 (2016), which is herein incorporated by reference in its entirety.

An example embodiment may utilize a threshold t to create mask M as shown in a righthand portion of example Equation (6) above. In an embodiment, a position of the mask M corresponding to a given weight w of the model may have a value of one (1) if the weight's importance is above the threshold τ, and zero (0) otherwise. An example embodiment may apply this mask M to a gradient while updating parameters of a student model. In an embodiment, masking the gradient may ensure that parameters containing the most information about the forget dataset are updated. Masking may also help preserve performance of the student model on the retain set by leaving untouched most of the weights that contain information about the retain set.

### Example Unlearning Method

In an embodiment, a procedure for unlearning is shown in example Method 1 below:

Example Method 1 Unlearning Procedure

| | |
|---|---|
| 1: | Initialize: Teacher and Student Models with [symbol] _{θ}* |
| 2: | for i = 1 to E do |
| 3: | // θⁱ is the Student Model at the i-th iteration |
| 4: | // Compute each element M_{θ}_{ⱼ} of mask M |
| 5: | for each θⱼ ∈ θⁱ do |
| 6: | ${M}_{{θ}_{j}} = 𝕝 ( \vert {θ}_{j} \cdot \frac{\partial {ℒ}_{CE}}{\partial {θ}_{j}} \vert > 𝒯 )$ |
| 7: | end for |
| 8: | for each input xₖ in batch Bⁱ of D_{f} do |
| 9: | x_{k,ood} = xₖ + n // Noise n ~ Distribution [symbol] |
| 10: | ${o}_{k}^{T} = {ℱ}_{{θ}^{*}}^{T} ( {x}_{k , ood} ) // Teacher Model {ℱ}_{{θ}^{*}}^{T}$ |
| 11: | ${o}_{k}^{S} = {ℱ}_{{θ}^{i}}^{S} ( {x}_{k} ) // Student Model {ℱ}_{{θ}^{i}}^{S}$ |
| 12: | end for |
| 13: | ${ℒ}_{KL} = \frac{1}{\vert {B}^{i} \vert} {\sum }_{{x}_{k}} {D}_{KL} ( {σ}_{s} ( {o}_{k}^{T} ) , {σ}_{s} ( {o}_{k}^{S} ) )$ |
| 14: | ${ℒ}_{E} = \frac{1}{\vert {B}^{i} \vert} {\sum }_{{x}_{k}} {\sum }_{y} {e}^{{o}_{k , y}^{S} ( {x}_{k} ) / T}$ |
| 15: | [symbol] _{MU} = [symbol] _{KL} + λ [symbol] _{E} |
| 16: | θⁱ = θⁱ⁻¹ − μₛₜₑₚ(M ⊙ ∇ [symbol] _{MU}) |
| 17: | end for |
| 18: | Output: Unlearned model [symbol] _{θf} = [symbol] _{θE} |

The following is a brief description of the unlearning steps in example Method 1 above. In an embodiment, at line 1, both teacher and student ML models (e.g., DNNs) are initialized with [symbol] _{θ*}. At lines 5-7, gradient mask M for a forget dataset is computed using

$${ℱ}_{{θ}^{i}}^{S}$$

at an i-th update step. Next, at lines 8-12, a batch Bⁱ of samples from the forget dataset D_{f} is fed to the student model, while noise (e.g., Gaussian or Bernoulli noise) is combined with the samples to generate corresponding corrupted samples, which are then fed to the teacher model. At line 13, KL divergence D_{KL} is computed and then used to compute KD loss [symbol] _{KL} at line 13. In turn, at line 14, energy loss [symbol] _{E} is computed for the student model

$${ℱ}_{{θ}^{i}}^{S} .$$

At line 15, the energy and KD losses are combined to arrive at total machine unlearning (MU) loss [symbol] _{MU}. Finally, at line 16, θⁱ is updated according to example Equation (7) below:

$${θ}^{i} - {θ}^{i - 1} - {μ}_{step} ( M ⊙ ∇ {ℒ}_{MU} ) \qquad ( 7 )$$

According to an embodiment, both the updated student model after each batch Bⁱ and after each iteration epoch i may be denoted as 04. In an embodiment, the steps in lines 5-16 of example Method 1 may be performed for E number of epochs. A result at line 18 is unlearned model [symbol] _{θf}. Details about example hyperparameters (e.g., number of unlearning epochs, noise configuration, gradient threshold, etc.) are provided hereinbelow.

### Example Hyperparameter Settings Evaluation Protocol

It may be desirable for a CMU approach to work for different classes while using the same hyperparameter settings. To accomplish this, in an embodiment, the below example protocol for evaluating hyperparameters may be used:
a) Perform hyperparameter tuning for one class; and
b) Evaluate remaining classes with the same hyperparameter settings.

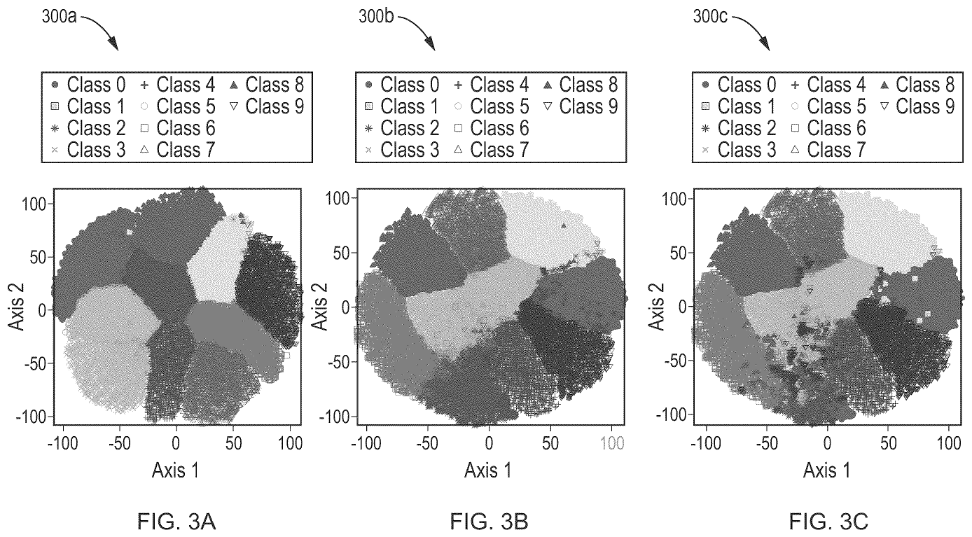

Example Class 2 of FIGS. 3A-3C (described hereinbelow) was selected for hyperparameter tuning using the above example protocol. This protocol was followed for example baseline approaches (described hereinbelow), as well as for an example embodiment, and the best performances from the hyperparameter tuning stage of the protocol were reported as described hereinbelow. The resulting hyperparameters were also used to evaluate the example baseline approaches and the example embodiment on additional classes from FIGS. 3A-3C. The evaluation results are reported hereinbelow.

### Example Hyperparameter Values

Below are non-limiting example hyperparameter values according to an embodiment:
a) For Gaussian noise added to an input of a teacher ML model, a value of μ=0 may be used. Noise strength σ² may be randomly varied from 0.5 to 1. It is noted that a small value of sigma may not resemble OOD data, while a large value can possibly resemble random soft labels. To balance these two extremes, an example embodiment may randomly vary noise strength so that information about training data is not entirely removed, while resembling OOD data as closely as possible.
b) For hyperparameter λ used to balance KD and energy loss in example Equation (5) (described hereinabove), a fixed value of 0.1 may be specified.
c) For importance threshold r used as part of generating gradient masks, its value may be specified as a 99^{th} quantile of R(w) in example Equation (6) (described hereinabove). Using this value may cause an example embodiment to update only the few most important weights for a forget set.

### Example Experimental Setup

### Example Datasets

Experiments were conducted on the CIFAR10 and VGGFace2 datasets to benchmark unlearning performance image classification and facial recognition tasks, respectively. Additional experiments were conducted on the CIFAR100 image classification dataset. Other known datasets are also suitable. A subset of 480 classes was used from VGGFace2. Results for Class 2 from CIFAR10, as well as results for additional CIFAR10 classes, are described hereinbelow.

### Example ML Model Architectures

For both CIFAR10 and CIFAR100, experiments were performed with both the ResNet20 deep learning architecture and VIT DNN architectures. Other known ML model architectures are also suitable. For VGGFace2, the ViT-Large DNN architecture was used. A rationale for selecting particular DNN architectures may be to demonstrate that embodiments can generalize across different types of DNNs, such as Convolutional Neural Networks (CNNs) and transformer architectures. A small CNN, i.e., ResNet20, was selected for investigating an impact of DNN capacity on CMU approaches. Details of example training procedures for the models are provided hereinbelow.

### Example Hardware Specifications

Experiments were performed on a Dell® Precision Tower 3650. The machine has 16 CPU cores with 32 GB of RAM. The machine also has a NVIDIA® RTX A4000 GPU with 16 GB of memory.

The experiment on VGGFace2 was performed on a machine with 48 cores and 512 GB of RAM. A NVIDIA A100 GPU with 80 GB of memory was used.

Other known hardware configurations are also suitable.

### Example ML Model Training

a) The ResNet model was trained from scratch for 182 epochs on CIFAR benchmarks with a batch size of 256. A learning rate of 0.1 was used with multi-step learning rate reductions to one-tenth of the current value at steps 91 and 136. A Stochastic Gradient Descent (SGD) optimizer was used with momentum 0.9 to minimize cross-entropy loss. Other known epoch numbers, batch sizes, learning rates, optimizers, and momentum values are also suitable.
b) For the transformer models, pretrained models from the timm repository of the Hugging Face® library were used. The models were adapted to run on the CIFAR benchmarks. The patch size was changed to 4 (four) and the image size was changed to 32. Other known patch and image sizes are also suitable. The models were fine-tuned for 50 epochs with the SGD optimizer with momentum 0.9 to minimize cross-entropy loss. A learning rate of 0.01 was used. Other known epoch numbers, optimizers, momentum values, and learning rates are also suitable.
c) The pretrained models from the timm repository were also adapted to run on the VGGFace2 dataset. An image size of 224×224 was used. Other known image sizes are also suitable. The models were fine-tuned for 20 epochs with the SGD optimizer with momentum 0.9 to minimize cross-entropy loss. A learning rate of 0.01 was used. Other known epoch numbers, optimizers, momentum values, and learning rates are also suitable.

### Example Retraining from Scratch

When retraining from scratch, the same configuration as training from scratch was used for ResNet architectures, while the same configuration as fine-tuning was used for transformer architectures.

### Example Baseline Approaches

For baseline comparison purposes, six traditional machine unlearning approaches along with the existing gold standard approach-retraining from scratch-were implemented as described hereinbelow.

A sweep was performed through learning rate values μ∈[0.001, 0.00001] and number of iterations E ∈{2, 5, 8, 10, 12, 14, 16, 18, 20} for all the baselines. Additionally, the SGD optimizer was used with a momentum value of 0.9 and 0 (zero) weight-decay for optimization of the ML models.

Below are details of retraining from scratch and the six traditional machine unlearning approaches:
a) Retrain
   i. This approach retrains a ML model (e.g., DNN) from scratch by using a retain dataset. Because this approach represents an upper bound of performance, i.e., exact unlearning, it is used as the gold standard and deviations or gaps between Retrain and the other approaches are reported in terms of the evaluated performance metrics.
b) Random Labels (RL)
   i. In this approach, samples of a forget dataset are randomly relabeled. A ML model is fine-tuned using this relabeled forget dataset. In data-constrained settings, only the forget dataset with random labels may be used for fine-tuning.
c) Gradient Ascent (GA)
   i. This approach focuses on maximizing training loss for a forget dataset. In classification tasks, this means maximizing cross-entropy loss for the forget dataset. For a batch of samples X, ML model parameters are updated using Equation (8) below:

$${θ}^{i} = {θ}^{i - 1} + μ ∇ {ℒ}_{cross entropy} \qquad ( 8 )$$

d) Influence Unlearning (IU)
   i. This approach uses a known influence function formulation. It measures parameter changes (Δθ) in a ML model when a forget dataset is excluded from training. The changes are estimated as H⁻¹∇L [symbol] _{f}; θ₀), where:
      1) H⁻¹ is an inverse Hessian matrix;
      2)

$${∇}_{θθ}^{2} L ( 𝒟 ; {θ}_{0} )$$

is evaluated at θ₀; and
3) ∇L [symbol] _{f}; θ₀) is a gradient of a loss function for the forget dataset.

The updated parameters (θ_{MU}) are given by θ_{MU}=θ₀+Δθ
e) Boundary Unlearning (BU)
   i. This approach encompasses two techniques:
      1) The BE technique introduces an additional neuron in a final layer of, e.g., a DNN, to represent a “dummy” class. Samples of a forget class are assigned to this dummy class, and the resulting forget dataset is used to fine-tune the DNN. After fine-tuning, the dummy class is removed.
      2) With the BS technique, samples of a forget class are adversarially perturbed using procedures like Fast Gradient Sign Method (FGSM) or Projected Gradient Descent (PGD). The samples are relabeled based on a predicted class of their perturbed counterparts. The relabeled dataset is then used to fine-tune the ML model.
f) Lipschitz Unlearning (LU)
   i. This approach aims to align representations of a forget dataset with their heavily corrupted counterparts. Corruption is introduced through strong Gaussian noise, and the approach minimizes a Lipschitz constant of a ML model. The Lipschitz constant is estimated according to Equation (9) below:

$$k = \frac{{‖ f ( x ) - f ( {x}_{noisy} ) ‖}^{2}}{‖ x - {x}_{noisy} ‖} \qquad ( 9 )$$

where k is the Lipschitz constant, x is the clean input, and x_{noisy} is the noisy counterpart.
g) Unlearning by Selective Impair and Repair (UNSIR)
   i. This approach does not require access to a forget dataset, but uses a retain dataset. A proxy forget dataset is created from optimized noise to unlearn a forget class. The default process has two steps:
      1) Impair Step: Noise is optimized to maximize training loss for the forget dataset. The noise is then used to fine-tune a ML model. For the baseline comparisons described herein, only this step was used.
      2) Repair Step: The model is fine-tuned on the retain dataset to preserve generalization. For the baseline comparisons described herein, this step was omitted.

Other known baseline approaches are also suitable.

Because only BU and LU ordinarily account for limited access to data, the remaining baseline approaches were adapted to use only a forget set.

### Example Performance Metrics

Although no generally accepted performance metrics exist for CMU, the following known metrics (a)-(e) were used, together with edge computing metrics (f) and (g):
a) Unlearning Accuracy (UA)—measures accuracy of a ML model (e.g., DNN) on a forget dataset;
b) Remaining Accuracy (RA)—accuracy of a ML model on a retain set;
c) Testing Accuracy (TA)—accuracy of a ML model on a test set of retained classes;
d) Membership Inference Attack (MIA)—infers whether a sample belongs to a training set or not;
e) Run Time Efficiency (RTE)—time (in seconds) taken to perform an unlearning process;
f) Energy—an amount of energy consumption for performing unlearning in an edge device measured in joules; and
g) Latency-time taken (in seconds) to perform unlearning in an edge device.

Other known performance and edge computing metrics are also suitable.

For MIA, a known confidence-based attack was implemented and a percentage of forget samples correctly predicted as non-training samples was used as a metric of unlearning performance.

Methods for confidence-based attacks may be as described in Song et al., “Privacy risks of securing machine learning models against adversarial examples,” In Proceedings of the 2019 ACM SIGSAC conference on computer and communications security, pp. 241-257, 2019, and Yeom et al., “Privacy risk in machine learning: Analyzing the connection to overfitting,” 2018 IEEE 31st computer security foundations symposium (CSF), IEEE, 2018, which are herein incorporated by reference in their entireties.

It is noted that the first four metrics (a)-(d), i.e., UA, RA, TA, and MIA, are reported as percentages hereinbelow. Gaps between the performance of (i) retraining from scratch (i.e., the gold standard) and (ii) the six conventional machine unlearning approaches (i.e., GA, RL, IU, BE, BS, LU, and UNSIR) and an example embodiment were computed for each of the metrics (a)-(d) and their averages are reported hereinbelow to describe the overall performance of the approaches.

### Example Experimental Results

### Example Unlearning Efficacy

Tables 1 and 2 below compare the performance of an example embodiment (CLUE) against the baselines on the ViT-Base architecture trained on CIFAR10 and CIFAR100. As discussed hereinabove, the unlearning performance was measured using the gaps with the Retrain gold standard for the four metrics UA, RA, TA, and MIA. The average of the gaps across the four metrics is also reported. It is observed from the results that the example embodiment outperforms all the conventional baselines. Specifically, BS and BE are the closest to the example embodiment in terms of average gap, while the example embodiment yields performance improvement by 4.44% and 3.95% on the CIFAR10 benchmark and 2.78% and 4.6% on the CIFAR100 benchmark for ViT-Base.

TABLE 1
Performance on ViT-Base trained on CIFAR10. Numbers
in parentheses denote gaps with Retrain.

| Unlearning | | | | | Average |
|---|---|---|---|---|---|
| Methods | UA | RA | TA | MIA | Gap |
| Retrain | 0 | 99.8 | 96.92 | 100 | |
| GA | 94.57 | 99.28 | 96.55 | 5.42 | 47.485 |
| | (94.57) | (0.52) | (0.37) | (94.48) | |
| RL | 0.02 | 84.11 | 81.56 | 99.62 | 7.8725 |
| | (0.02) | (15.69) | (15.4) | (0.38) | |
| IU | 97.26 | 99.35 | 97.10 | 2.70 | 49.02 |
| | (97.26) | (0.45) | (−1.08) | (97.3) | |
| BE | 0 | 89.27 | 85.12 | 100 | 5.58 |
| | (0) | (10.53) | (11.8) | (0) | |
| BS | 4.73 | 92.33 | 89.55 | 95.26 | 6.07 |
| | (4.73) | (7.47) | (7.37) | (4.74) | |
| LU | 0 | 11.11 | 11.11 | 100 | 43.36 |
| | (0) | (87.66) | (85.81) | (0) | |
| UNSIR | 98.91 | 99.26 | 97.01 | 1.08 | 49.61 |
| | (98.91) | (0.54) | (−0.09) | (98.92) | |
| CLUE | 2.04 | 98.42 | 95.86 | 97.95 | 1.63 |
| (Ours) | (2.04) | (1.38) | (1.06) | (2.05) | |

TABLE 2
Performance on ViT-Base trained on CIFAR100. Numbers
in parentheses denote gaps with Retrain.

| Unlearning | | | | | Average |
|---|---|---|---|---|---|
| Methods | UA | RA | TA | MIA | Gap |
| Retrain | 0 | 99.24 | 85.72 | 100 | |
| GA | 0.44 | 92.03 | 81.50 | 99.55 | 3.08 |
| | (0.44) | (7.21) | (4.22) | (0.45) | |
| RL | 25.99 | 91.63 | 81.08 | 74 | 16.06 |
| | (25.99) | (7.59) | (4.68) | (26) | |
| IU | 86.22 | 92.72 | 82.18 | 13.77 | 45.64 |
| | (86.22) | (6.48) | (3.54) | (86.33) | |
| BE | 0 | 81.84 | 71.39 | 100 | 7.97 |
| | (0) | (17.60) | (14.33) | (0) | |
| BS | 0 | 85.32 | 75.01 | 100 | 6.15 |
| | (0) | (13.92) | (10.71) | (0) | |
| LU | 0 | 1.01 | 1.01 | 0 | 45.73 |
| | (0) | (98.23) | (84.71) | (0) | |
| UNSIR | 26.22 | 41.99 | 36.12 | 73.77 | 48.60 |
| | (26.22) | (57.25) | (84.60) | (26.33) | |
| CLUE | 0.22 | 91.24 | 80.77 | 99.77 | 3.37 |
| (Ours) | (0.22) | (8) | (4.95) | (0.33) | |

Tables 3 and 4 below compare the performance of an example embodiment against the baselines on the ResNet20 architecture trained on CIFAR10 and CIFAR100. It is observed that the example embodiment generalizes across different architectures and performs better than the conventional baselines. The example embodiment improves upon the nearest baseline by 4.74% on CIFAR10 and by 0.4% on CIFAR100. It is further observed that existing approaches such as LU and UNSIR consistently perform poorly. This is expected, because the UNSIR approach forgets by directly learning from noise. Using strong noise impairs information about a forget dataset, yet it also hampers the overall performance. LU processes each sample separately, and as such, parameters of batch-norm layers cannot capture characteristics of a dataset, thus hurting generalization. The observed performance of the baseline approaches is discussed in further detail hereinbelow. In summary, the average performance of the example embodiment across all evaluated metrics is the best among the baselines. To emphasize the performance of the example embodiment, when evaluated in terms of relative improvement from the nearest conventional approach, the example embodiment achieves 27.28% gains, reaching as high as 70% on the ViT-Base architecture with the CIFAR 10 dataset.

TABLE 3
Performance on ResNet20 trained on CIFAR10.
Parentheses denote gaps with Retrain.

| Unlearning | | | | | Average |
|---|---|---|---|---|---|
| Methods | UA | RA | TA | MIA | Gap |
| Retrain | 0 | 99.75 | 90.18 | 100 | |
| GA | 8.66 | 79.43 | 76.54 | 91.33 | 12.83 |
| | (8.66) | (20.32) | (13.64) | (8.77) | |
| RL | 20 | 89.50 | 82.22 | 78.50 | 14.92 |
| | (20) | (10.25) | (7.96) | (21.5) | |
| IU | 17.77 | 94.05 | 87.87 | 82.22 | 10.89 |
| | (17.77) | (5.70) | (2.31) | (17.78) | |
| BE | 24 | 91.63 | 83.33 | 76 | 15.74 |
| | (24) | (8.12) | (6.85) | (24) | |
| BS | 46.17 | 93.26 | 86.58 | 53.82 | 25.63 |
| | (46.17) | (6.49) | (3.7) | (46.18) | |
| LU | 0 | 11.11 | 11.11 | 100 | 69.42 |
| | (0) | (88.64) | (89.07) | (0) | |
| UNSIR | 0 | 14.37 | 14.23 | 100 | 40.33 |
| | (0) | (85.38) | (75.95) | (0) | |
| CLUE | 10.48 | 96.61 | 89.7 | 89.50 | 6.15 |
| (Ours) | (10.48) | (3.14) | (0.48) | (10.50) | |

TABLE 4
Performance on ResNet20 trained on CIFAR100.
Parentheses denote gaps with Retrain.

| Unlearning | | | | | Average |
|---|---|---|---|---|---|
| Methods | UA | RA | TA | MIA | Gap |
| Retrain | 0 | 87.84 | 62.85 | 100 | |
| GA | 0 | 50.18 | 43.24 | 100 | 14.31 |
| | (0) | (37.62) | (19.61) | (0) | |
| RL | 8.66 | 67.52 | 54.45 | 91.33 | 11.53 |
| | (8.66) | (20.32) | (8.4) | (8.77) | |
| IU | 0 | 62.16 | 51.50 | 100 | 9.24 |
| | (0) | (25.68) | (11.30) | (0) | |
| BE | 1.11 | 62.60 | 51.60 | 98.88 | 9.66 |
| | (1.11) | (25.24) | (11.20) | (1.12) | |
| BS | 2.44 | 62.95 | 51.55 | 96.66 | 10.48 |
| | (2.44) | (24.89) | (11.25) | (3.34) | |
| LU | 0 | 1.20 | 1.10 | 0 | 62.10 |
| | (0) | (86.64) | (61.75) | (100) | |
| UNSIR | 0 | 1.58 | 1.58 | 0 | 61.88 |
| | (0) | (86.26) | (61.27) | (100) | |
| CLUE | 3.77 | 68.11 | 54.75 | 96.22 | 8.84 |
| (Ours) | (3.77) | (19.73) | (8.10) | (3.78) | |

### Example Unlearning Results on Additional Classes

Example unlearning results on additional CIFAR classes are provided in Tables 5 through 12 below.

TABLE 5
Additional results for ViT-Base trained
on CIFAR10 and forget Class 0.

| Unlearning | | | | | |
|---|---|---|---|---|---|
| Methods | UA | RA | TA | MIA | Gap |
| Retrain | 0 | 99.73 | 97.15 | 100 | 0 |
| GA | 0 | 11.11 | 11.11 | 100 | 43.67 |
| | (0.00) | (88.62) | (86.04) | (0.00) | |
| RL | 21.51 | 81.22 | 80.56 | 59.63 | 24.25 |
| | (21.51) | (18.51) | (16.59) | (40.37) | |
| IU | 98.04 | 99.31 | 96.91 | 1.95 | 49.19 |
| | (98.04) | (0.42) | (0.24) | (98.05) | |
| BE | 29.5 | 93.58 | 90.73 | 69.24 | 18.21 |
| | (29.50) | (6.15) | (6.42) | (30.76) | |
| BS | 31.24 | 93.87 | 91.18 | 68.75 | 18.58 |
| | (31.24) | (5.86) | (5.97) | (31.25) | |
| LU | 0 | 11.11 | 11.11 | 100 | 43.67 |
| | (0.00) | (88.62) | (86.04) | (0.00) | |
| UNSIR | 99.15 | 99.02 | 96.42 | 0.84 | 49.94 |
| | (99.15) | (0.71) | (0.73) | (99.16) | |
| CLUE | 0 | 98.6 | 96.07 | 100 | 0.55 |
| | (0.00) | (1.13) | (1.08) | (0.00) | |

TABLE 6
Additional results for ViT-Base trained
on CIFAR10 and forget Class 6.

| Unlearning | | | | | |
|---|---|---|---|---|---|
| Methods | UA | RA | TA | MIA | Gap |
| Retrain | 0 | 99.73 | 96.72 | 100 | |
| GA | 0 | 11.11 | 11.11 | 100 | 43.56 |
| | (0.00) | (88.62) | (85.61) | (0.00) | |
| RL | 23.52 | 86.31 | 85.22 | 63.52 | 21.23 |
| | (23.52) | (13.42) | (11.50) | (36.48) | |
| IU | 99.2 | 99.29 | 94.74 | 0.8 | 50.21 |
| | (99.20) | (0.44) | (1.98) | (99.20) | |
| BE | 43.29 | 96.58 | 95.83 | 55.24 | 23.02 |
| | (43.29) | (3.15) | (0.89) | (44.76) | |
| BS | 42.93 | 97.59 | 94.75 | 57.06 | 22.50 |
| | (42.93) | (2.14) | (1.97) | (42.94) | |
| LU | 0 | 11.11 | 11.11 | 100 | 43.56 |
| | (0.00) | (88.62) | (85.61) | (0.00) | |
| UNSIR | 98.02 | 92.28 | 88.95 | 1.97 | 52.82 |
| | (98.02) | (7.45) | (7.77) | (98.03) | |
| CLUE | 0 | 98 | 94.77 | 100 | 0.92 |
| | (0.00) | (1.73) | (1.95) | (0.00) | |

TABLE 7
Additional results for ViT-Base trained
on CIFAR100 and forget Class 0.

| Unlearning | | | | | |
|---|---|---|---|---|---|
| Methods | UA | RA | TA | MIA | Gap |
| Retrain | 0 | 99.51 | 86.57 | 100 | 0 |
| GA | 91.77 | 92.58 | 81.98 | 8.22 | 48.77 |
| | (91.77) | (6.93) | (4.59) | (91.78) | |
| RL | 0 | 55.12 | 49.62 | 100 | 20.34 |
| | (0.00) | (44.39) | (36.95) | (0.00) | |
| IU | 94.44 | 92.65 | 82 | 5.5 | 50.09 |
| | (94.44) | (6.86) | (4.57) | (94.50) | |
| BE | 0 | 78.3 | 68.54 | 100 | 9.81 |
| | (0.00) | (21.21) | (18.03) | (0.00) | |
| BS | 0 | 68.68 | 61.58 | 100 | 13.96 |
| | (0.00) | (30.83) | (24.99) | (0.00) | |
| LU | 0 | 1.01 | 1.01 | 0 | 71.02 |
| | (0.00) | (98.50) | (85.56) | (100.00) | |
| UNSIR | 46.14 | 81.33 | 40.43 | 18.66 | 47.95 |
| | (46.14) | (18.18) | (46.14) | (81.34) | |
| CLUE | 0 | 89.67 | 79.2 | 100 | 4.30 |
| | (0.00) | (9.84) | (7.37) | (0.00) | |

TABLE 8
Additional results for ViT-Base trained
on CIFAR100 and forget Class 12.

| Unlearning | | | | | |
|---|---|---|---|---|---|
| Methods | UA | RA | TA | MIA | Gap |
| Retrain | 0 | 99.26 | 85.21 | 100 | 0 |
| GA | 74.66 | 92.68 | 82.13 | 25.33 | 39.75 |
| | (74.66) | (6.58) | (3.08) | (74.67) | |
| RL | 0 | 71.35 | 66.23 | 100 | 11.72 |
| | (0.00) | (27.91) | (18.98) | (0.00) | |
| IU | 84.66 | 92.72 | 82.18 | 15.33 | 44.73 |
| | (84.66) | (6.54) | (3.03) | (84.67) | |
| BE | 0 | 53.79 | 47.51 | 100 | 20.79 |
| | (0.00) | (45.47) | (37.70) | (0.00) | |
| BS | 0 | 86.16 | 75.92 | 100 | 5.60 |
| | (0.00) | (13.10) | (9.29) | (0.00) | |
| LU | 0 | 1.01 | 1.01 | 0 | 70.61 |
| | (0.00) | (98.25) | (84.20) | (100.00) | |
| UNSIR | 26.22 | 41.99 | 36.12 | 73.77 | 39.70 |
| | (26.22) | (57.27) | (49.09) | (26.23) | |
| CLUE | 0 | 89.19 | 79.24 | 100 | 4.01 |
| | (0.00) | (10.07) | (5.97) | (0.00) | |

TABLE 9
Additional results for ResNet20 trained
on CIFAR10 and forget Class 0.

| Unlearning | | | | | |
|---|---|---|---|---|---|
| Methods | UA | RA | TA | MIA | Gap |
| Retrain | 0 | 99.69 | 89.53 | 100 | 0 |
| GA | 11.92 | 93.54 | 84.61 | 88.55 | 8.61 |
| | (11.92) | (6.15) | (4.92) | (11.45) | |
| RL | 8.56 | 81.23 | 78.55 | 88.3 | 12.43 |
| | (8.56) | (18.46) | (10.98) | (11.70) | |
| IU | 17.77 | 94.05 | 87.87 | 82.22 | 10.71 |
| | (17.77) | (5.64) | (1.66) | (17.78) | |
| BE | 14.8 | 92.15 | 83.8 | 85.2 | 10.72 |
| | (14.80) | (7.54) | (5.73) | (14.80) | |
| BS | 24.6 | 90.74 | 83.37 | 75.4 | 16.08 |
| | (24.60) | (8.95) | (6.16) | (24.60) | |
| LU | 0 | 11.11 | 11.11 | 0 | 66.75 |
| | (0.00) | (88.58) | (78.42) | (100.00) | |
| UNSIR | 0.02 | 13.22 | 12.9 | 99.97 | 40.79 |
| | (0.02) | (86.47) | (76.63) | (0.03) | |
| CLUE | 11.64 | 92.65 | 87.02 | 88.35 | 8.21 |
| | (11.64) | (7.04) | (2.51) | (11.65) | |

TABLE 10
Additional results for ResNet20 trained
on CIFAR10 and forget Class 6.

| Unlearning | | | | | |
|---|---|---|---|---|---|
| Methods | UA | RA | TA | MIA | Gap |
| Retrain | 0 | 99.78 | 89.53 | 100 | 0 |
| GA | 12.53 | 91.52 | 80.66 | 85.22 | 11.11 |
| | (12.53) | (8.26) | (8.87) | (14.78) | |
| RL | 20.11 | 83.14 | 81.23 | 82.11 | 15.74 |
| | (20.11) | (16.64) | (8.30) | (17.89) | |
| IU | 27.56 | 90.05 | 82.34 | 83.72 | 15.19 |
| | (27.56) | (9.73) | (7.19) | (16.28) | |
| BE | 6.48 | 80.44 | 73.56 | 93.51 | 12.07 |
| | (6.48) | (19.34) | (15.97) | (6.49) | |
| BS | 15.2 | 86.5 | 79.12 | 87.79 | 12.78 |
| | (15.20) | (13.28) | (10.41) | (12.21) | |
| LU | 0 | 11.11 | 11.11 | 0 | 66.77 |
| | (0.00) | (88.67) | (78.42) | (100.00) | |
| UNSIR | 6.86 | 11.78 | 11.48 | 93.11 | 44.95 |
| | (6.86) | (88.00) | (78.05) | (6.89) | |
| CLUE | 10.77 | 93.19 | 86.3 | 89.4 | 7.80 |
| | (10.77) | (6.59) | (3.23) | (10.60) | |

TABLE 11
Additional results for ResNet20 trained
on CIFAR100 and forget Class 0.

| Unlearning | | | | | |
|---|---|---|---|---|---|
| Methods | UA | RA | TA | MIA | Gap |
| Retrain | 0 | 87.71 | 61.94 | 100 | 0 |
| GA | 0 | 52.74 | 43.2 | 100 | 13.43 |
| | (0.00) | (34.97) | (18.74) | (0.00) | |
| RL | 14.44 | 61.8 | 50.96 | 85.55 | 16.45 |
| | (14.44) | (25.91) | (10.98) | (14.45) | |
| IU | 0 | 55.33 | 41.28 | 88.25 | 16.20 |
| | (0.00) | (32.38) | (20.66) | (11.75) | |
| BE | 2.22 | 63.65 | 51.56 | 97.77 | 9.72 |
| | (2.22) | (24.06) | (10.38) | (2.23) | |
| BS | 1.77 | 64.86 | 52.37 | 98.22 | 8.99 |
| | (1.77) | (22.85) | (9.57) | (1.78) | |
| LU | 4.66 | 0.59 | 0.63 | 95.33 | 39.44 |
| | (4.66) | (87.12) | (61.31) | (4.67) | |
| UNSIR | 0 | 2.25 | 2.22 | 0 | 61.30 |
| | (0.00) | (85.46) | (59.72) | (100.00) | |
| CLUE | 3.77 | 55.49 | 46.63 | 96.22 | 13.77 |
| | (3.77) | (32.22) | (15.31) | (3.78) | |

TABLE 12
Additional results for ResNet20 trained
on CIFAR100 and forget Class 12.

| Unlearning | | | | | |
|---|---|---|---|---|---|
| Methods | UA | RA | TA | MIA | Gap |
| Retrain | 0 | 87.52 | 62.45 | 100 | 0 |
| GA | 13.55 | 61.9 | 48.22 | 83.61 | 17.45 |
| | (13.55) | (25.62) | (14.23) | (16.39) | |
| RL | 0.55 | 45.16 | 43.67 | 81.16 | 20.13 |
| | (0.55) | (42.36) | (18.78) | (18.84) | |
| IU | 0 | 55.33 | 41.28 | 88.25 | 16.28 |
| | (0.00) | (32.19) | (21.17) | (11.75) | |
| BE | 1.55 | 58.99 | 48.63 | 98.44 | 11.37 |
| | (1.55) | (28.53) | (13.82) | (1.56) | |
| BS | 1.55 | 62.81 | 50.93 | 98.44 | 9.84 |
| | (1.55) | (24.71) | (11.52) | (1.56) | |
| LU | 0 | 0.82 | 0.85 | 0 | 62.08 |
| | (0.00) | (86.70) | (61.60) | (100.00) | |
| UNSIR | 0 | 1.56 | 1.66 | 0 | 61.69 |
| | (0.00) | (85.96) | (60.79) | (100.00) | |
| CLUE | 7.55 | 62.51 | 50.73 | 92.44 | 12.96 |
| | (7.55) | (25.01) | (11.72) | (7.56) | |

### Example Results of Baseline Approaches

The GA approach performs best for CIFAR100 with a ViT base architecture. By design, GA effectively removes knowledge of a forget class by increasing its loss. However, indiscriminate weight updates can harm a retain set's accuracy, as observed for CIFAR10, CIFAR100, and ResNet20.

RL is conceptually very close to the BE and BS approaches. In RL, samples of a forget class are relabeled randomly. Fine-tuning with this relabeled forget class likely undoes a previously learned association of the samples of the forget class with the class label. This phenomenon causes a ML model (e.g., DNN) to perform poorly on the forget class. At the same time, this phenomenon causes samples of the forget class to start being associated with class labels of a retain class. Depending on the relabeling process (which is randomized), a decision space may need to change drastically. For instance, a sample from the forget class may be assigned to a distant class. This can reduce accuracy of the model on the retain set. Such a loss of accuracy is observed in the reported results-good UA performance is accompanied by a drop in RA and TA for RL.

The IU approach performs poorly, especially for ViT architectures. While IU shows comparable performance for ResNet20 on CIFAR100, IU's inconsistency across datasets and architectures indicates weak generalization.

Results from the BE and BS approaches may indicate that one aspect of CMU is removing forget samples from a decision space. BE and BS are limited in their ability to retain a generalization capability of a ML model. By causing direct assignment of samples of a forget set to the nearest class, BE and BS may also confuse the model. This can happen because semantically similar samples from the forget set may be assigned to different retain set classes. For example, it is observed that even with ViT and CIFAR10 datasets, these approaches lose accuracy on the retain training set and test set by up to 10.53% and 11.58% respectively. As a further example, it is observed that RL—a more extreme version of the BS and BE approaches performs even worse and loses 15.4% accuracy on the test set of the CIFAR10 retain dataset.

An example embodiment may determine an optimal learning rate for unlearning in a range between 10⁻³ and 10⁻⁵. In an embodiment, 10⁻³ may be selected as the lower end of the range because the last learning rate for a ML model during training is 10⁻³. According to another embodiment, 10⁻⁵ may be selected as the upper end of the range based on empirical results from an existing approach.

The LU approach generally underperforms. LU aligns ML model outputs with corrupted inputs by minimizing the Lipschitz constant, which negatively impacts retain set accuracy. Two reasons for this are:
a) Direct estimation of the Lipschitz constant may fail to protect retain set information; and
b) Batch normalization statistics align with corrupted inputs, disrupting retain set performance.

The UNSIR approach performs poorly across metrics for ViT. For evaluation purposes, retain set samples were not used for the repair step, and training with noise reduces generalization significantly.

### Example Computational Complexity

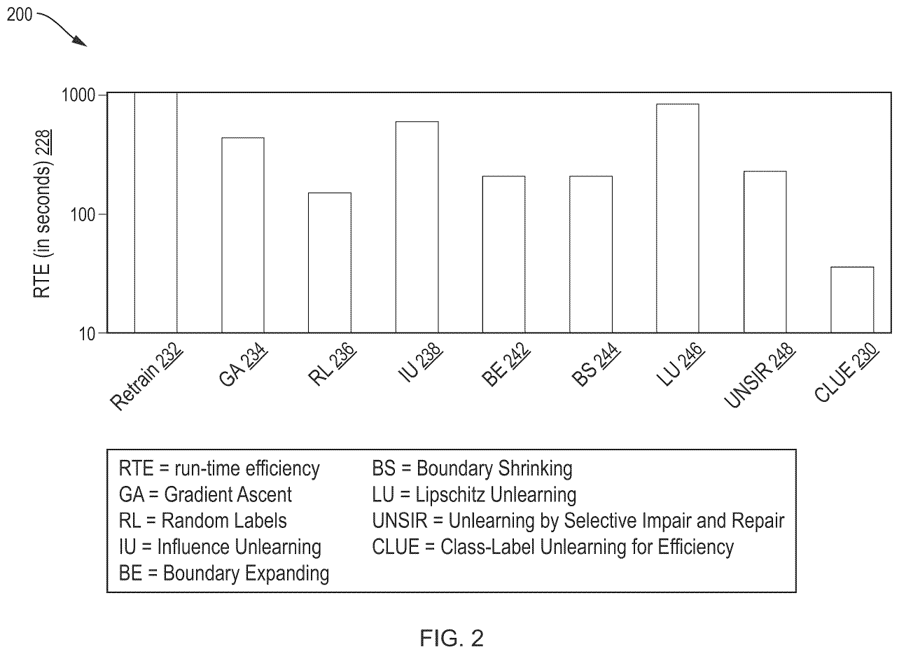

FIG. 2 is a graph 200 showing RTE 228 results in logarithmic scale for Retrain 232, GA 234, RL 236, IU 238, BE 242, BS 244, LU 246, UNSIR 248, and an example system 230 according to an embodiment (CLUE).

The results in FIG. 2 are obtained for ViT-Base and CIFAR10. It is observed that every traditional baseline 234, 236, 238, 242, 244, 246, and 248 is faster than the Retrain approach 232. Even when fine-tuning a ViT-Base model pretrained on ImageNet on CIFAR10, it takes about 1035 seconds for performance to stabilize on a retain dataset. Compared to the Retrain approach 232, the example system 230 provides 28.7× better RTE 228; it also has 5.77× better RTE 228 than the BE 242 and BS 244 approaches. The reason the system 230 is faster than the BS 244 approach is that the system 230 does not need to search for the nearest class (thereby necessitating use of FGSM or PGD) for each sample, which is computationally expensive. While the system 230 performs inference twice for each input-once for the teacher (e.g., 110 (FIG. 1)) ML model and once for the student (e.g., 120 (FIG. 1)) model—these operations can be parallelized. In addition, the BE 242 approach modifies a ML model, e.g., DNN, architecture by adding an additional node at the last layer, which requires retraining. A partial explanation of the low RTE 228 of the system 230 is the low number of iterations required for unlearning, which is further described hereinbelow.

### Example Iterations for Unlearning

One reason for the improved RTE of embodiments is the low number of iterations required. For instance, an example embodiment may require only 8 (eight) iterations for both the CIFAR10 and CIFAR100 datasets for the ViT-Base architecture. On the same architecture and datasets, Bl/requires 16 iterations and RL requires 14 iterations. Similarly, for the ResNet20 architecture, an example embodiment may require only 5 (five) iterations, while BU and RL require 8 (eight) and 12 iterations, respectively.

### Example Decision Spaces

FIGS. 3A-3C are plots 300a-300c, respectively, of an example decision space according to an embodiment. FIG. 3A depicts the decision space before unlearning. FIG. 3B depicts the decision space after unlearning with respect to ground truth labels (not shown). FIG. 3C depicts the decision space after unlearning with respect to predicted labels (not shown).

To understand the impact of an example embodiment on a decision space of a ML model (e.g., DNN), the decision space is visualized in FIGS. 3A-3C for a training set before and after an unlearning process for a forget class. The results 300a-300c are based on ResNet20 trained on the ten Classes 0-9 from CIFAR10, because larger datasets are impractical to visualize. The forget class is Class 2.

An output of a penultimate layer may be used to visualize the decision space. To reduce a resulting high-dimensional (e.g., having 64 dimensions) feature map obtained from the penultimate layer, the t-SNE statistical technique may be utilized. Other known statistical techniques are also suitable. The scikit-learn scientific toolkit may be used to implement t-SNE by setting a perplexity value to 3 and representing the data with two components, leaving other hyperparameters unchanged. Other known scientific toolkits and perplexity values are also suitable. Axis 1 and Axis 2 in FIGS. 3A-3C refer to the two components returned by the model.

FIG. 3A depicts the decision space before performing the unlearning where well-clustered classes correspond to high model accuracy (>99%).

FIG. 3B shows the decision space after unlearning, plotted with respect to the ground truth labels. The plot 300b helps in understanding a current decision boundary of the DNN. It is noted that, although rearranged, the classes (i.e., Classes 0, 1, and 3-9) in the retain dataset still form tight clusters, which helps preserve accuracy. The rearrangement of the Classes 0-9 in the decision space is due to a stochastic nature of ML model (e.g., DNN) training, which makes the model converge to a different local minimum during the unlearning process. Moreover, an area for the forget class (Class 2) in the decision space has shrunk. UA=10.48 (as shown in Table 3 above describing example performance on ResNet20 trained on CIFAR10) indicates some retention of information of the forget class. However, minimal overlap with the retain datasets suggests that performance on the retain set is preserved.

FIG. 3C shows that inputs from the forget class (Class 2) are being reassigned to different classes, which indicates erasure of the information about the forget class. In turn, this forces the model to rely on the remaining classes for inference, thus demonstrating successful unlearning.

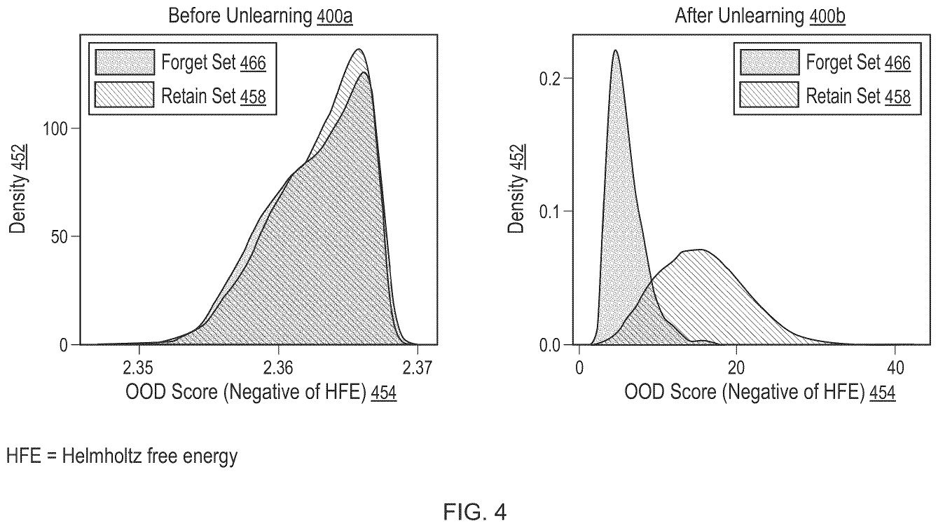

FIG. 4 depicts example distributions 400a and 400b of HFE before and after unlearning, respectively, according to an embodiment. The distributions 400a and 400b illustrate density 452 of OOD scores 454 based on CIFAR10 and ResNet20 for retain set 458 and forget set 466. The forget class 466 is treated as OOD. In an embodiment, the forget set 466 and the retain set 458 may be indicated with different color shading in the distributions 400a and 400b, while areas of overlap between the forget set 466 and the retain set 458 may be indicated with shading in yet another color.

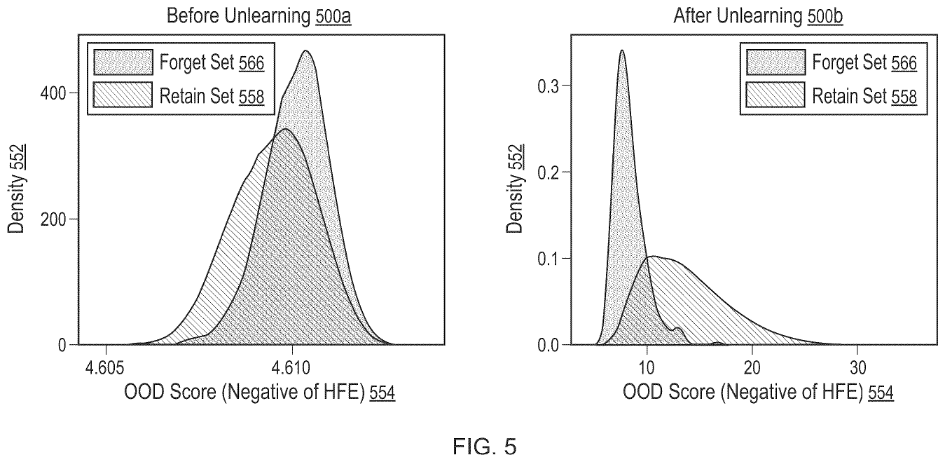

FIG. 5 depicts example distributions 500a and 500b of HFE before and after unlearning, respectively, according to another embodiment. The distributions 500a and 500b illustrate density 552 of OOD scores 554 based on CIFAR100 and ResNet20 model for retain set 558 and forget set 566. The forget class 566 is treated as OOD.

FIGS. 4 and 5 show the distributions 400a/400b and 500a/500b, respectively, of the HFE before (400a/500a) and after (400b/500b) the unlearning with example embodiments, that plot the OOD scores 454 and 554, i.e., the negatives of the HFE. As shown in the distributions 400a and 500a, before unlearning, samples of the respective forget datasets 466 and 566 and retain datasets 458 and 558 have indistinguishable OOD scores 454 and 554. After unlearning with example embodiments, it is observed from the distributions 400b and 500b that the samples in the respective forget datasets 466 and 566 have lower OOD scores 454 and 554 (or higher HFE) than the retain datasets 458 and 558. In summary, example embodiments may shrink a decision boundary of the forget classes 466 and 566 and force their samples to appear as OOD.

### Example Outperformance of ViTs

Example results show that ViTs outperform ResNets in unlearning performance, with a 4.92% and 5.47% gain on CIFAR10 and CIFAR100, respectively. This phenomenon may be attributed to ViTs' self-attention mechanism and larger capacity, which enable more disentangled class representations. This explanation is also supported by improved unlearning from ResNet20 to ViT; however, performance drops by 1.74% as dataset complexity increases as shown in Tables 1 and 2 (described hereinabove). On VGGFace2 with ViT-Large, an example embodiment (CLUE) doubles baseline performance, but the gap with Retrain widens to 7.77% as shown in Table 13 below.

TABLE 13
Performance of an example embodiment on ViT-Large trained
on VGGFace2. Parentheses denote gaps with Retrain.

| Unlearning | | | | | |
|---|---|---|---|---|---|
| Methods | UA | RA | TA | MIA | Gap |
| Retrain | 0 | 98.25 | 89.36 | 100 | 0 |
| BE | 9.50 | 80.4 | 72.35 | 90.30 | 13.51 |
| | (9.50) | (17.85) | (17.01) | (9.70) | |
| BS | 8.70 | 81.25 | 70.43 | 92.34 | 13.07 |
| | (8.70) | (17) | (18.93) | (7.66) | |
| CLUE | 3.20 | 85.20 | 76.30 | 98.20 | 7.77 |
| (Ours) | (3.20) | (13.05) | (13.06) | (1.80) | |

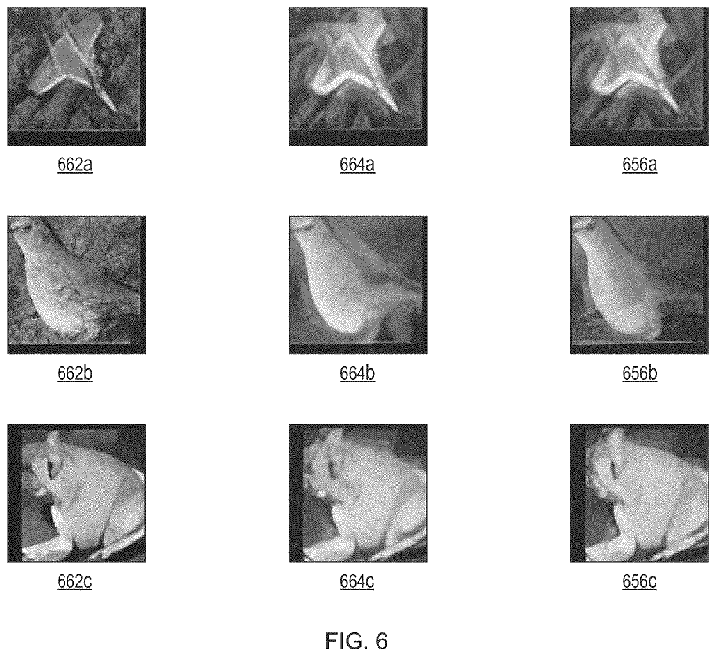

FIG. 6 illustrates example attention maps 664a, 664b, and 664c before unlearning and example attention maps 656a, 656b, and 656c after unlearning of ViT-Base for original images 662a, 662b, and 662c of Classes 0 (airplane), 2 (bird), and 6 (frog), respectively, of CIFAR10 according to an embodiment. Class 2 is a forget class.

As demonstrated by FIG. 6, the attention mechanism in ViT helps it to focus on important parts of the images 662a-662c for inference. It is noted that an example embodiment can effectively reshape the attention maps 664b/656b of the forget class (i.e., Class 2) to achieve better unlearning performance, whereas the attention maps are almost unchanged before 664a/664c and after 656a/656c unlearning for Class 0 and Class 6, respectively. However, the map 656b for Class 2 shows decreased attention after unlearning and thus cannot capture a structure of the bird 662b. This shows that a successful unlearning approach for ViT selectively modifies attention heads to lose focus on a forget dataset while retaining focus on a retain dataset. FIG. 6 also illustrates effects of an example embodiment on forget samples instead of a forget class. In other words, successful unlearning makes it harder for a ML model (e.g., DNN) to capture salient features of the forget samples and focus on generic features learned across different classes of a retain set. This is supported by the fact that, in FIG. 6, ViT fails to detect the shape of the bird 662b while focusing on partial features like eyes common to other animal classes, e.g., frog Class 6.

### Example Embodiments Versus Random Soft Labels

Because an example embodiment may use strong noise to simulate a logit distribution of OOD data, it is possible that the corrupted inputs' logit distribution may resemble that of randomly assigned soft labels. To test whether an example embodiment is merely equivalent to assigning random soft labels, performance of an embodiment was compared with a random soft-labeling approach in Table 14 below. The results reveal a significant performance gap of up to 40%, demonstrating that simply using random soft labels is insufficient for effective unlearning. A significant difference may be explained in part by the fact that, unlike the example embodiment, random soft labeling significantly degrades performance on a retain set. This results from the generation process of random soft labels. Because these labels are essentially randomly generated logits passed through softmax activation, they likely do not resemble any categorical distribution that can be generated by a ML model, e.g., DNN. Moreover, because the soft labels essentially encode information about all classes, anomalous soft labels can be harmful for updating the model as shown by Table 14 below. This demonstrates that the soft labels generated by a teacher ML model in an example embodiment are fundamentally different from random soft labels.

TABLE 14
Comparison of an example embodiment (CLUE) versus assigning random soft
labels to forget samples. Parentheses denote gaps with Retrain.

| Dataset/ | Unlearning | | | | | | | | Average |
|---|---|---|---|---|---|---|---|---|---|
| Architecture | Methods | UA | RA | | TA | | MIA | | Gap |
| CIFAR10 | Retrain | 0 | 99.8 | | 96.92 | | 100 | | |
| ViT Base | CLUE | 2.04 (2.04) | 98.42 | (1.38) | 95.86 | (1.06) | 97.95 | (2.05) | 1.63 |
| | Random | 24.4 (24.4) | 97.17 | (2.63) | 94.44 | (2.48) | 75.6 | (24.4) | 13.47 |
| | Softlabel | | | | | | | | |
| CIFAR100 | Retrain | 0 | 99.24 | | 85.72 | | 100 | | |
| ViT Base | CLUE | 0.22 (0.22) | 91.24 | (8) | 80.77 | (4.95) | 99.77 | (26.33) | 3.37 |
| | Random | 0 (0) | 51.41 | (47.83) | 47.48 | (38.24) | 0 | (0) | 43.04 |
| | Softlabel | | | | | | | | |
| CIFAR10 | Retrain | 0 | 99.75 | | 90.18 | | 100 | | |
| Resnet20 | CLUE | 10.48 (10.48) | 96.61 | (3.14) | 89.7 | (0.48) | 89.50 | (10.50) | 6.15 |
| | Random | 18.48 (18.48) | 76.41 | (23.34) | 70.54 | (19.64) | 79.50 | (21.50) | 20.74 |
| | Softlabel | | | | | | | | |
| CIFAR100 | Retrain | 0 | 87.84 | | 62.85 | | 100 | | |
| Resnet20 | CLUE | 3.77 (3.77) | 68.11 | (19.73) | 54.75 | (8.10) | 96.22 | (3.78) | 8.84 |
| | Random | 0 (0) | 45.71 | (42.13) | 41.49 | (21.36) | 100 | (0) | 15.87 |
| | Softlabel | | | | | | | | |

### Example Ablation Study

An example embodiment was tested with (i) KD loss and gradient masking, (ii) energy loss and gradient masking, (iii) KD loss, energy loss, and gradient masking, and (iv) KD and energy loss without gradient masking. The ablation study was performed for CIFAR10 and ResNet20. The results are shown in Table 15 below. It is noted that removing gradient masking has the most significant impact on performance, with the average (avg.) gap with Retrain increasing by 14.41%. Next, removing KD loss incurs an average gap increase of almost 4%, highlighting its role in learning a posterior distribution of OOD data. Without KD loss, a ML model (e.g., DNN) may optimize energy loss, thereby sacrificing retain set accuracy in favor of unlearning performance. Finally, the smallest gap was observed without energy loss, although including it improved performance by over 1%.

TABLE 15
Ablation study for an example embodiment.
Parentheses denote gaps with Retrain.

| Approach | UA | RA | TA | MIA | Avg. Gap |
|---|---|---|---|---|---|
| Retrain | 0 | 99.75 | 90.18 | 100 | |
| KD LOSS + | 13.04 | 95.58 | 88.71 | 87.95 | 7.6825 |
| Gradient | (13.04) | (4.17) | (1.47) | (12.05) | |
| Masking | | | | | |
| Energy Loss + | 16.71 | 94.64 | 88.41 | 83.28 | 10.0775 |
| Gradient | (16.71) | (5.11) | (1.77) | (16.72) | |
| Masking | | | | | |
| KD Loss + | 10.48 | 96.61 | 89.7 | 89.51 | 6.1475 |
| Energy Loss + | (10.48) | (3.14) | (0.48) | (10.49) | |
| Gradient | | | | | |
| Masking | | | | | |
| KD Loss + | 0 | 56.4 | 51.3 | 100 | 20.55 |
| Energy Loss | (0) | (43.34) | (38.88) | (0) | |

### Example Mobile Device Implementation

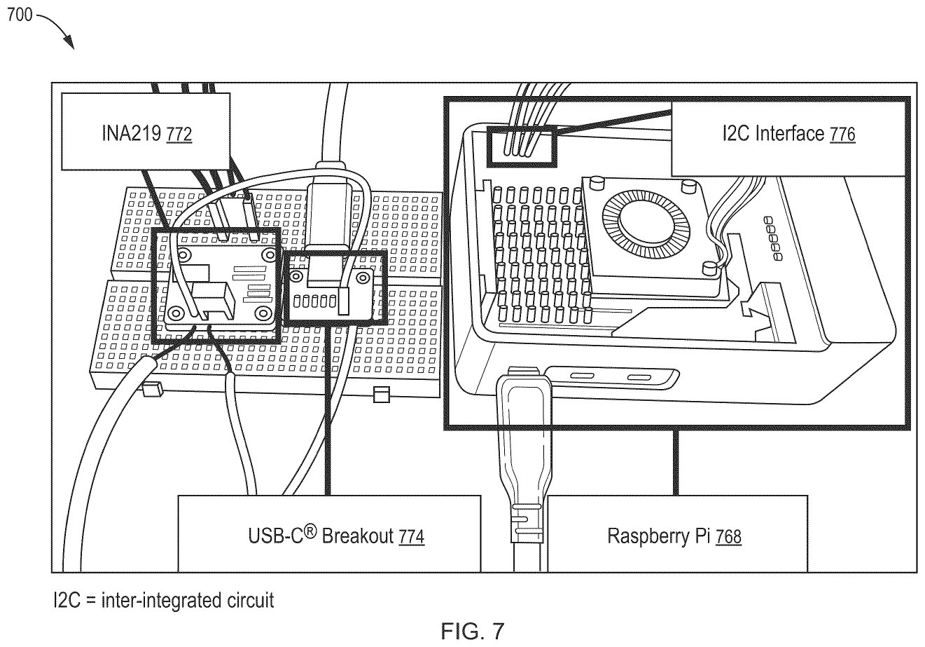

FIG. 7 is a composite image of an example experimental setup 700 for power and latency measurement on an edge or mobile device according to an embodiment. As shown in FIG. 7, the experimental setup 700 includes edge device 768, power monitor 772, breakout board 774, and inter-integrated circuit (I2C) interface 776.

Continuing with FIG. 7, an example embodiment was implemented using a Raspberry Pi 5 single-board computer (SBC) as the edge device 768 for running mobile computer vision (CV) applications. The Raspberry Pi was equipped with a quad-core Arm® A76 system on a chip (SoC) running at a clock speed of up to 2.4 GHz with 8 GB LPDDR4 memoryᵢ other known computing devices are also suitable. An Adafruit® INA-219 sensor was used as the power monitor 772 to sample current usage by the device 768 and calculate power averaged over all test samples; other known power monitors are also suitable. The breakout board 774 together with the power monitor 772 were used to form a power supply to the device 768. Using the I2C interface 776, current from the power monitor 772 was sampled and communicated to the device 768 to compute power usage.

Latency is reported as the time including any pre- or post-processing involved. Cold-start effects are purposefully included in the measurements to reflect real-world edge deployment scenarios where devices may frequently restart or handle sporadic requests. All batches, including initial ones, are included in latency reporting. The latency measurements were averaged over 5 (five) runs.

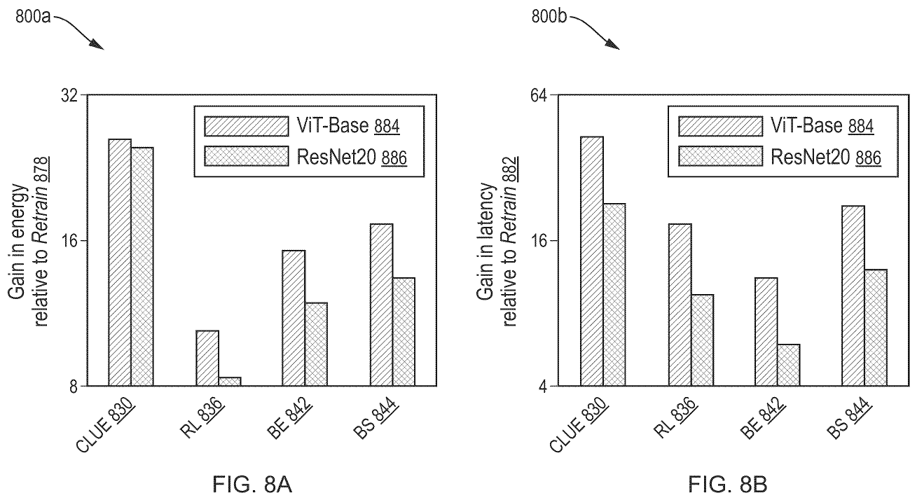

FIGS. 8A and 8B are graphs 800a and 800b comparing example latency and energy measurements, respectively, according to an embodiment. The graph 800a illustrates gain in energy 878 relative to Retrain on Raspberry Pi 5 for RL 836, BE 842, and BS 844 baseline approaches, and an example system 830 according to an embodiment (CLUE). The graph 800b illustrates gain in latency 882 relative to Retrain on Raspberry Pi 5 for the RL 836, BE 842, and BS 844 approaches, and the example system 830.

Continuing with FIGS. 8A and 8B, the example embodiment 830 and the closest baselines 836, 842, and 844 for CIFAR100 were run on both ResNet20 model 886 and ViT-Base architecture 884. FIG. 8A shows that the example embodiment 830 outperforms the baseline approaches 836, 842, and 844 in terms of the gain in energy 878. Specifically, the example embodiment 830 utilizes 25× less energy and is 33× faster than Retrain and is 68% faster and consumes 90% less energy than the BE approach 842. Apart from that, it is observed that for the ViT-Base architecture 884 and an example batch size of 32, the example embodiment 830 uses 2598 MB of peak memory while the BS approach 844 takes 3729 MB, which indicates about 30% improvement in terms of memory consumption. Other known batch sizes are also suitable. To continue, for the ResNet20 model 886, memory consumption of the example embodiment 830 is 69.5 MB while the BS approach 844 requires 116.81 MB.

### Example Effects on Hard Inputs from Retain Set

To understand how an example embodiment affects hard examples—i.e., samples closer to a decision boundary—in a retain set, an experiment was conducted to measure a percentage of samples at varying distances from the boundary that change labels due to unlearning. This experiment was performed using CIFAR10 and ViT-Base.

To provide a comprehensive view, two metrics were plotted against a distance from the nearest decision boundary:
a) A percentage of samples that change labels after unlearning; and
b) A percentage of samples that are corrected after unlearning.

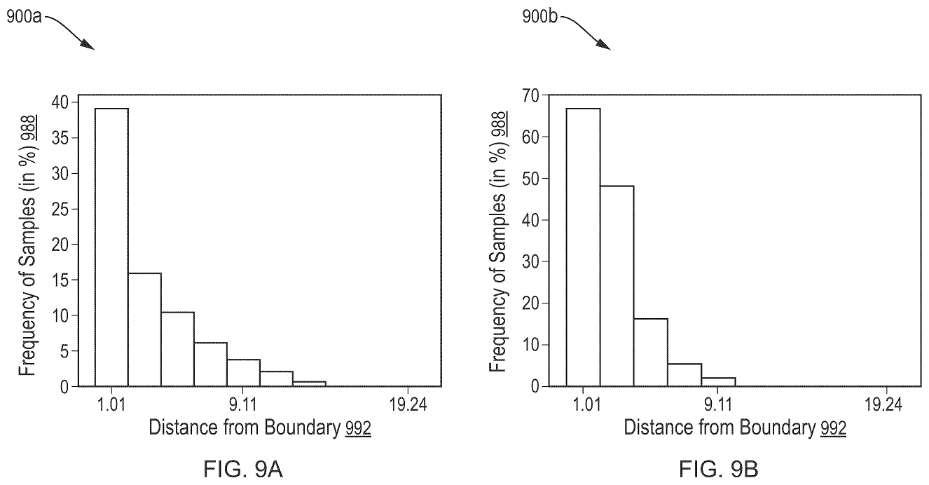

FIG. 9A is a graph 900a showing a percentage 988 of samples that change labels due to unlearning relative to their distances 992 from a decision boundary, according to an embodiment. FIG. 9B is a graph 900b showing the percentage 988 of the samples that were misclassified before unlearning but are corrected after unlearning relative to their distances 992 from the decision boundary, according to an embodiment. All the samples belong to a retain set.

The results of FIGS. 9A and 9B reveal that samples closest to the decision boundary are the most affected. As shown in FIG. 9A, these hard samples change labels far more frequently than easier ones. Additionally, unlearning leads to a rearrangement of the decision space, allowing samples near the boundary to be corrected more often.

### Example Comparison with SalUn

An example embodiment is compared with the existing SalUn approach in Table 16 below. For a fair comparison, SalUn was adapted so that it does not use data from a retain set. The gradient mask generation setup and random labeling approach from SalUn were used. While unlearning, only a forget set was used for model updates and the retain set was excluded. The objective function was modified to be

$${min}_{Δθ} {L}_{SalUn}^{( 1 )} ( {θ}_{u} ) = {𝔼}_{( x , y ) \sim {𝒟}_{f} , {y}^{′} \neq y} [ {ℓ}_{CE} ( {θ}_{u} ; x , {y}^{′} ) ]$$

where [symbol] _{f} is the forget set and y′ is a random label other than a label of a forget class. While sweeping for optimal hyperparameters, the same range as reported in SalUn was followed. It is observed that the example embodiment outperforms SalUn by up to 12.57%. The example embodiment performs much better than SalUn especially for CIFAR10, while the margin shrinks with an increase in class numbers for CIFAR100.

TABLE 16
Comparison of an example embodiment (CLUE) with SalUn. Parentheses denote gaps with Retrain.

| Dataset/ | Unlearning | | | | | | | | Average |
|---|---|---|---|---|---|---|---|---|---|
| Architecture | Methods | UA | RA | | TA | | MIA | | Gap |
| CIFAR10/ViT Base | Reunin | 0 | 99.8 | | 96.92 | | 100 | | |
| | CLUE | 2.04 (2.04) | 98.42 | (1.38) | 95.86 | (1.06) | 97.95 | (2.05) | 1.63 |
| | SalUn | 11.55 (11.55) | 97.80 | (2) | 96.72 | (0.2) | 56.95 | (43.05) | 14.2 |
| CIFAR100/ViT Base | Retrain | 0 | 99.24 | | 85.72 | | 100 | | |
| | CLUE | 0.22 (0.22) | 91.24 | (8) | 80.77 | (4.95) | 99.77 | (26.33) | 3.37 |
| | SalUn | 0 (0) | 81.53 | (17.71) | 71.92 | (13.8) | 100 | (0) | 4.42 |
| CIFAR10/Resnet20 | Retrain | 0 | 99.75 | | 90.18 | | 100 | | |
| | CLUE | 10.48 (10.48) | 96.61 | (3.14) | 89.7 | (0.48) | 89.50 | (10.50) | 6.15 |
| | SalUn | 18.33 (18.33) | 95.51 | (4.24) | 89.07 | (1.11) | 81.66 | (18.34) | 10.505 |
| CIFAR100/Resnat20 | Retrain | 0 | 87.84 | | 62.85 | | 100 | | |
| | CLUE | 3.77 (3.77) | 68.11 | (19.73) | 54.75 | (8.10) | 96.22 | (3.78) | 8.84 |
| | SalUn | 5.33 (5.33) | 67.52 | (20.32) | 54.31 | (8.51) | 94.88 | (5.12) | 9.82 |

### Example Effects of Varying Forget Set Size

To examine sensitivity of unlearning performance to a size of a forget set, experiments were conducted using different fractions of the full forget set. Specifically, the proportion of samples to be forgotten was varied across the range {10%, 25%, 50%, 75%, 95%, 100%}. This setup allows for characterizing how effectively an unlearning approach scales as more or fewer samples are designated for removal.

Table 17 below reports results on CIFAR10 and CIFAR100 with ViT-Base. It is observed that an example embodiment maintains stable performance across a wide range of forget set sizes. In particular, UA remains consistently close to 0 (zero), which indicates that forgotten classes are successfully suppressed. Meanwhile, RA and TA experience only modest degradation, which confirms that knowledge of retained data is largely preserved. The MIA success rate also remains low, which indicates that unlearning according to an embodiment reduces privacy leakage even under adversarial evaluation.

TABLE 17
Unlearning results for an example embodiment (CLUE) on CIFAR10 and CIFAR100 with
ViT-Base by varying a forget set size. Parentheses denote gaps with Retrain

| Dataset | Architecture | Method | Forget % | UA | RA | TA | MIA | Avg Gap |
|---|---|---|---|---|---|---|---|---|
| CIFAR-10 | ViT-Base | Retrain | — | 0 | 99.8 | 96.92 | 100 | — |

| | | | | | | | | |
|---|---|---|---|---|---|---|---|---|
| CLUE | 100% | 0 (0) | 95.36 | (4.44) | 92.77 (4.15) | 100 | (0) | 2.15 |
| | 95% | 0 (0) | 94.85 | (4.95) | 92.11 (4.81) | 100 | (0) | 2.44 |
| | 75% | 2.04 (2.04) | 98.42 | (1.38) | 95.86 (1.06) | 97.95 | (2.05) | 1.63 |
| | 50% | 1.52 (1.52) | 96.92 | (2.88) | 95.86 (1.06) | 98.24 | (1.76) | 1.81 |
| | 25% | 0.53 (0.53) | 94.51 | (5.29) | 92.04 (4.88) | 99 | (1) | 2.92 |
| | 10% | 2.89 (2.89) | 96.96 | (2.84) | 94.24 (2.68) | 95.6 | (4.4) | 3.20 |

| | | | | | | | | |
|---|---|---|---|---|---|---|---|---|
| CIFAR-100 | ViT-Base | Retrain | — | 0 | 99.24 | 85.72 | 100 | — |

| | | | | | | | | |
|---|---|---|---|---|---|---|---|---|
| CLUE | 100% | 0.22 (0.22) | 91.24 | (8.0) | 80.77 (4.95) | 99.77 | (26.33) | 3.37 |
| | 95% | 0.23 (0.23) | 91.07 | (8.17) | 80.71 (5.01) | 99.77 | (0.23) | 3.41 |
| | 75% | 0 (0) | 90.77 | (8.47) | 85.49 (0.23) | 100 | (0) | 2.18 |
| | 50% | 0 (0) | 90.82 | (8.42) | 80.49 (5.23) | 100 | (0) | 3.42 |
| | 25% | 0 (0) | 87.13 | (12.11) | 76.43 (9.29) | 100 | (0) | 5.35 |
| | 10% | 0 (0) | 89.04 | (10.2) | 78.97 (6.75) | 100 | (0) | 4.24 |

Table 17 above indicates that the average gap remains consistently small across all configurations. On CIFAR10, variance of the gap is only 0.32 with standard deviation of 0.56, while on the more challenging CIFAR100 dataset the values are 0.93 and 0.96, respectively. These results demonstrate that the example embodiment is substantially more stable across different forget set sizes than existing baselines, maintaining performance close to Retrain levels even as the fraction of forgotten data varies. This highlights the robustness of embodiments and shows that unlearning can be applied reliably without requiring access to the entire forget set at once.

### Example Comparisons with Additional Existing Approaches

Table 18 below shows that an example embodiment (CLUE) consistently outperforms traditional approaches-zero-shot unlearning (ZSU) and source-free unlearning (SFU)—in both utility preservation and privacy. On CIFAR10, the example embodiment achieves performance close to Retrain levels, with only minor drops in RA (−1.4%) and TA (−1.1%), while maintaining high MIA robustness and a very low gap (1.63). The conventional approaches ZSU and SFU either catastrophically degrade retained knowledge, e.g., ZSU RA falls below 25%, or incur large gaps (>10%).

TABLE 18
Example comparison of unlearning approaches on CIFAR10 and CIFAR100
with ViT-Base. Parentheses denote gaps with Retrain.

| Dataset/ | Unlearning | | | | | | | | |
|---|---|---|---|---|---|---|---|---|---|
| Architecture | Method | UA | RA | | TA | | MIA | | Avg. Gap |
| CIFAR-10 | Retrain | 0 | 99.80 | | 96.92 | | 100 | | 0 |
| ViT-Base | CLUE | 2.04 (2.04) | 98.42 | (1.38) | 95.86 | (1.06) | 97.95 | (2.05) | 1.63 |
| | ZSU | 1.32 (1.32) | 24.54 | (75.26) | 21.78 | (75.14) | 10.20 | (89.80) | 60.38 |
| | SPU | 1.55 (1.55) | 85.30 | (14.50) | 80.45 | (16.47) | 92.33 | (7.67) | 10.05 |
| CIFAR-100 | Retrain | 0 | 99.24 | | 85.72 | | 100 | | 0 |
| ViT-Base | CLUE | 0.22 (0.22) | 91.24 | (8.00) | 80.77 | (4.95) | 99.77 | (26.33) | 3.37 |
| | ZSU | 3.77 (3.77) | 89.46 | (9.78) | 78.60 | (5.12) | 96.22 | (3.78) | 5.61 |
| | SFU | 2.33 (2.33) | 87.24 | (12.00) | 76.38 | (9.34) | 95.88 | (4.12) | 6.95 |

On the more challenging CIFAR 100 dataset, the example embodiment again yields the strongest tradeoff: UA is nearly 0 (zero), RA and TA remain close to retrain, and the gap is only 3.37-substantially lower than ZSU (5.61%) and SFU (6.95%). Importantly, MIA performance stays at near-ideal levels (˜ 1θ₀).

Overall, these results in Table 18 above demonstrate that the example embodiment provides balanced, stable unlearning across datasets, while ZSU and SFU either unlearn at the cost of the retain set performance or reduce privacy guarantees.

### Example Sequential Unlearning

The results in Table 19 below highlight the effectiveness of an example embodiment (CLUE) in sequential unlearning—i.e., where multiple classes are forgotten in order-compared to the conventional BS approach. On both CIFAR10 and CIFAR100 with ViT-Base, the example embodiment consistently achieves near-zero UA, closely matching the Retrain gold standard. This suppression of forgotten classes is also achieved without sacrificing RA or TA-performance degradation relative to Retrain is marginal (≤2.5%).

TABLE 19
Example comparison of unlearning approaches on CIFAR10 and CIFAR100
with ViT-Base. Parentheses denote gaps with Retrain.

| Dataset/ | Unlearned | Unlearning | | | | | | | | |
|---|---|---|---|---|---|---|---|---|---|---|
| Architecture | Classes | Method | UA | RA | | TA | | MIA | | Avg. Gap |
| CIFAR-10 | 2.8 | Retrain | 0 | 99.8 | | 96.92 | | 100 | | 0 |
| ViT-Base | | CLUE | 0.24 (0.24) | 97.42 | (2.38) | 95.36 | (1.56) | 99.95 | (0.05) | 1.06 |
| | | BS | 3.42 (3.42) | 89.66 | (10.14) | 84.23 | (12.69) | 92.55 | (7.45) | 8.43 |
| CIPAR-100 | 2.6 | Retrain | 0 | 91.84 | | 80.85 | | 100 | | 0 |
| ViT-Base | | CLUE | 0 (0) | 90.67 | (1.07) | 79.6 | (1.25) | 100 | (0) | 0.58 |
| | | BS | 24 (14) | 80.24 | (11.43) | 69.59 | (11.26) | 90.22 | (9.78) | 8.72 |

In contrast, BS incurs substantial drops in RA and TA (10⁻¹²% on average), which reflects significant leakage of unlearning into a retained set. This instability is further shown by the Average Gap metric, where the example embodiment maintains values under 1 (one), while BS shows large gaps exceeding 8 (eight). Moreover, the example embodiment preserves the MIA robustness of retraining (˜100%), whereas BS substantially weakens privacy guarantees.

Overall, the results demonstrate that the example embodiment not only scales well under sequential unlearning, but also delivers robust and stable performance across datasets, thus outperforming BS in both utility preservation and privacy protection.

### Example Effects of Noise Variance

Table 20 below shows that the performance of an example embodiment (CLUE) may correlate with injected noise strength. With very low variance (02=0.1), forgetting is incomplete (UA remains high at 38.37), despite strong RA. Moderate variance (02=0.5) reduces UA, but still leaves a noticeable gap. At higher variance (02=1.0), forgetting is achieved (UA˜0) but at the cost of significant RA/TA degradation. Assigning random variance in the range [0.5, 1.0] for each image achieves the best tradeoff, with near-zero UA, strong RA/TA, high MIA, and the smallest gap (3.37). This may result from the damaging effect of some samples exposed to high noise variance being compensated for by others receiving lower noise strength, thus leading to a more balanced outcome.

TABLE 20
Effects of varying noise strength (variance) in an example embodiment
on CIFAR100 with ViT-Base. Parentheses denote gaps with Retrain.

| Dataset/ | Unlearning | | | | | | | |
|---|---|---|---|---|---|---|---|---|
| Architecture | Method | UA | RA | | TA | MIA | | Avg. Gap |
| CIFAR-100 | Retrain | 0 | 99.24 | | 85.72 | 100 | | 0 |
| ViT-Base | CLUE (σ² = 0.1) | 38.37 (38.37) | 95.33 | (3.91) | 82.45 (3.27) | 63.78 | (36.22) | 20.44 |
| | CLUE (σ² = 0.5) | 13.22 (13.22) | 93.63 | (5.61) | 80.90 (4.82) | 95.27 | (4.73) | 7.10 |
| | CLUE (σ² = 1.0) | 0 (0) | 82.56 | (16.68) | 76.80 (8.92) | 96.22 | (3.78) | 7.35 |
| | CLUE (random σ² ∈ [0.5, 1.0]) | 0.22 (0.22) | 91.24 | (8.00) | 80.77 (4.95) | 99.77 | (26.33) | 3.37 |

### Experiment on Example Midsized Dataset

To evaluate the performance of an example embodiment on a midsized dataset, the Caltech256 dataset was used with the ViT-Base-16 architecture. Class 6 was used as a forget set. The results in Table 21 below show that RL, BE, and BS either incur substantial drops in RA/TA or fail to fully suppress forgotten classes, thus leading to larger gaps with Retrain (3.65-21.14). In contrast, the example embodiment achieves a balanced tradeoff, combining low UA with minimal RA/TA degradation, and delivers the smallest gap (1.78), thus highlighting its superior stability and effectiveness.

TABLE 21
Example comparison of unlearning approaches for
Caltech256 dataset and ViT-Base-16 architecture.
Parentheses denote gaps with Retrain.

| Unlearning Method | UA | RA | TA | MIA | Avg. Gap |
|---|---|---|---|---|---|
| Retrain | 0 | 95.50 | 77.32 | 100 | 0 |
| RL | 1.25 | 89.40 | 72.85 | 98.60 | 3.65 |
| | (1.25) | (6.10) | (4.47) | (1.40) | |
| BE | 0 | 87.65 | 74.20 | 100 | 4.33 |
| | (0) | (7.85) | (3.12) | (0) | |
| BS | 3.80 | 90.72 | 75.15 | 96.05 | 5.12 |
| | (3.80) | (4.78) | (2.17) | (3.95) | |
| ZSU | 57.34 | 92.34 | 72.44 | 81.3 | 21.135 |
| | (57.34) | (3.16) | (4.88) | (18.7) | |
| SFU | 10.34 | 92.33 | 74.67 | 93.4 | 5.665 |
| | (10.34) | (3.17) | (2.55) | (6.6) | |
| CLUE | 2.10 | 93.85 | 76.20 | 98.25 | 1.78 |
| | (2.10) | (1.65) | (1.12) | (1.75) | |

### Additional Example Visualizations

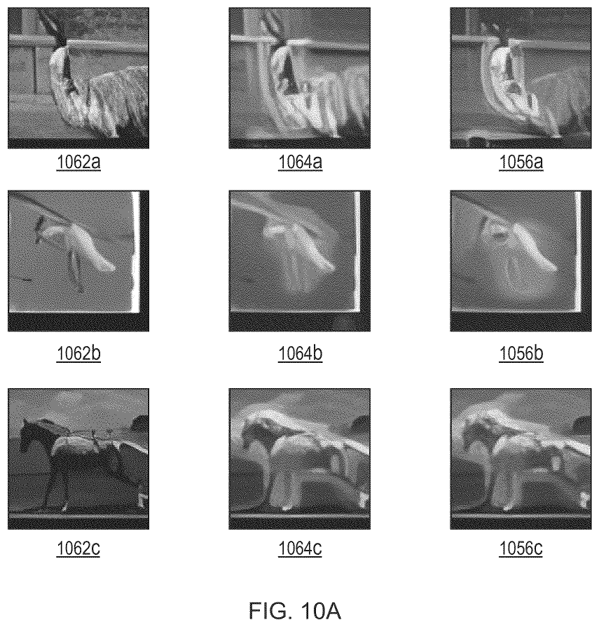

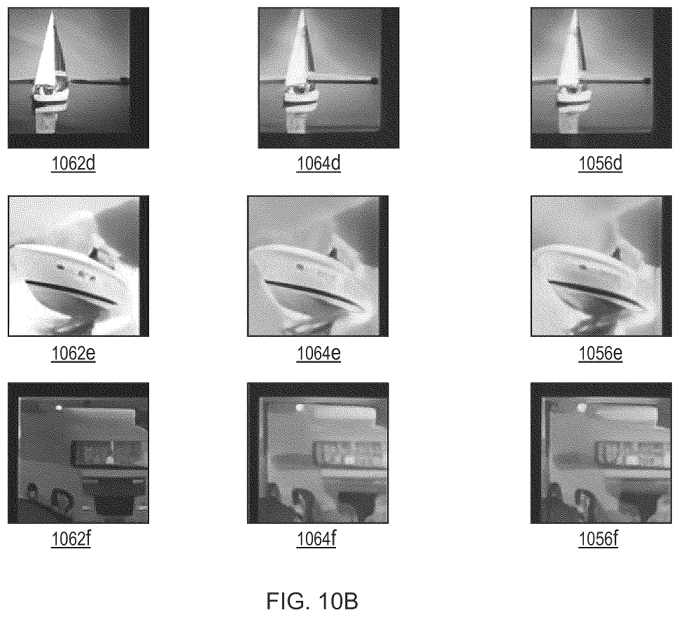

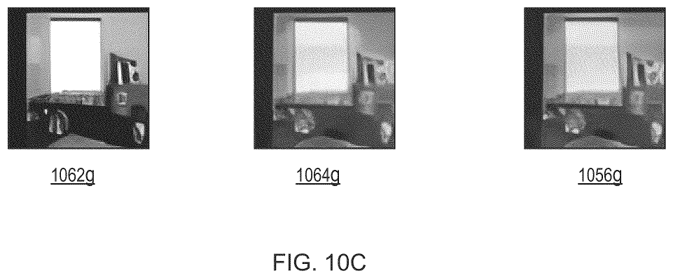

FIGS. 10A-10C illustrate example attention maps 1064a, 1064b, 1064c, 1064d, 1064e, 1064f, and 1064g before unlearning and example attention maps 1056a, 1056b, 1056c, 1056d, 1056e, 1056f, and 1056g after unlearning of ViT-Base for original images 1062a, 1062b, 1062c, 1062d, 1062e, 1062f, and 1062g, respectively, of Classes 2 (bird), 7 (horse), 8 (ship), and 9 (truck) of CIFAR10 according to an embodiment. Class 2 is a forget class. As shown in FIGS. 10A-10C, the gradient attention rollout maps 1064a/1056a and 1064b/1056b are significantly different for the forget class before and after unlearning while the maps 1064c/1056c, 1064d/1056d, 1064e/1056e, 1064f/1056f, and 1064g/1056g for the retain classes are almost the same.

According to an embodiment, FIGS. 10A-10C may be used for subjective evaluation of unlearning performance.

In an embodiment, to improve the visualizations, the images 1062a-1062g and their corresponding attention maps 1064a-1064g and 1056a-1056g may be up-sampled by 4 (four) times. From the adjusted visualizations, a shrink in the attention maps 1064a/1056a and 1064b/1056b for the forget class may be observed, while the remaining attention maps 1064c/1056c, 1064d/1056d, 1064e/1056e, 1064f/1056f, and 1064g/1056g are unchanged.

### Example Code for Implementing Embodiments

The Computer Program Listing Appendices are referred to as Appendix A (create_mask_from_gradients.txt), Appendix B (add_gaussian_noise.txt), Appendix C (add_salt_and_pepper_noise_batch.txt), Appendix D (ood_assisted_unlearning.txt), and Appendix E (ood_unlearning.txt), which are herein incorporated by reference in their entireties. A person having ordinary skill in the art can recognize that each of Appendices A-E can be renamed to substitute the “.txt” portion of the filename with “.py” to indicate that the file includes Python code to be executed in a Python environment. Other known programming languages are also suitable. To continue, Appendices A-E are example code that may be used to implement embodiments as described hereinbelow.

Appendix A defines a function create_mask_from_gradients ( ) that may be used to create a mask (e.g., 102 (FIG. 1)) based on weight salience of a forget dataset (e.g., 466 (FIG. 4) or 566 (FIG. 5)). In an embodiment, the function may take as inputs (i) a ML model (e.g., 110 (FIG. 1), 884 (FIG. 8A), or 886 (FIG. 8A)), (ii) test data (which may be accessed, e.g., via a PyTorch® DataLoader class or other suitable known data interface), and (iii) an optional threshold of gradient values for creating the mask. According to an embodiment, a default threshold value may be 0.1. Other known threshold values are also suitable. The function may return a set (e.g., dictionary) of Boolean masks for each parameter. In an embodiment, only a forget set may be utilized as the input test data. According to another embodiment, the create_mask_from_gradients ( ) function can be utilized for any desired dataset or subset of data.

Appendix B defines a function add gaussian noise ( ) that may be used to add Gaussian noise to input data. In an embodiment, the function may take as inputs a set of images and a corresponding set of standard deviations of the Gaussian noise to be added to each image. The function may return a set of images with the noise added. In an embodiment, the add gaussian noise ( ) function may be used to add the noise 108 (FIG. 1) to the input data 104 (FIG. 1).

Appendix C defines a function add_salt_and_pepper_noise_batch ( ) that may be used to add salt-and-pepper noise to input data. In an embodiment, the function may take as inputs a set of images, an optional salt probability value, and an optional pepper probability value. According to an embodiment, default salt and pepper probability values may each be 0.01. Other known probability values are also suitable. The function may return a set of images with the noise added. In an embodiment, the add_salt_and_pepper_noise_batch ( ) function may be used to add the noise 108 to the input data 104.

Appendix D defines a function ood_assisted_unlearning ( ) that may be used to implement unlearning steps described hereinabove such as with respect to the example framework 100 (FIG. 1) or the example Method 1. In an embodiment, the function may take as inputs (i) a pretrained ML model (e.g., 110 (FIG. 1)), (ii) input data (e.g., 104 (FIG. 1), 662a-662c (FIG. 6), or 1062a-1062g (FIG. 10)) from a forget set (e.g., 466 or 566), (iii) a gradient mask (e.g., 102 (FIG. 1)), and (iv) an optimizer (e.g., an SGD optimizer) to perform a gradient masking process (e.g., 126 (FIG. 1)). According to an embodiment, the add_salt_and_pepper_noise_batch ( ) function of Appendix C may be invoked with probability values of 0.5 to add noise to the input data. Other known noise functions are also suitable.

Appendix E defines a function ood_unlearning ( ) that may be called for Eᵢₜₑᵣ number of times to perform an example unlearning process according to an embodiment. In an embodiment, the function may take as inputs (i) a pretrained ML model (e.g., 110), (ii) a collection of datasets including data (e.g., 104, 662a-662c, or 1062a-1062g) from a forget set (e.g., 466 or 566), (iii) a criterion value of a number of iterations Eᵢₜₑᵣ, (iv) an optimizer (e.g., an SGD optimizer) to perform a gradient masking process (e.g., 126), and (v) an optional Boolean variable to specify use of gradient masking. According to an embodiment, a default value of the Boolean variable may be True. In an embodiment, if a value of the Boolean variable is True, the create_mask_from_gradients ( ) function of Appendix A may be invoked to create a gradient mask (e.g., 102).

### Example Method Embodiment

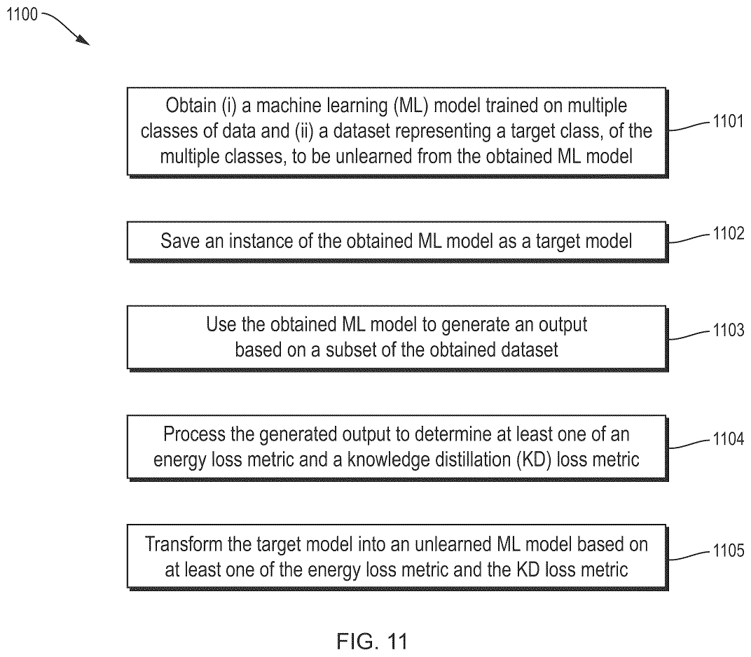

FIG. 11 is a flowchart of a method 1100 of unlearning. The method 1100 is computer-implemented and may be implemented using any computing device, e.g., a processor, or combination of computing devices known to those of skill in the art.

The method 1100 begins at step 1101 by obtaining (i) a ML model (e.g., 110 (FIG. 1)) trained on multiple classes of data and (ii) a dataset (e.g., 466 (FIG. 4) or 566 (FIG. 5)) representing a target class, of the multiple classes, to be unlearned from the obtained ML model. Next, at step 1102, an instance of the obtained ML model is saved as a target model (e.g., 120 (FIG. 1)). Iteratively, until a criterion is met, the method 1100: uses 1103 the obtained ML model to generate an output based on a subset (e.g., 104 (FIG. 1), 662a-662c (FIG. 6), or 1062a-1062g (FIG. 10)) of the obtained dataset; processes 1104 the generated output to determine at least one of an energy loss metric (e.g., 114 (FIG. 1)) and a KD loss metric (e.g., 116 (FIG. 1)); and transforms 1105 the target model into an unlearned ML model based on at least one of the energy loss metric and the KD loss metric.

According to an embodiment, the criterion for iteratively performing the using (1103), processing (1104), and transforming (1105) may be a desired number of epochs. For instance, with reference to example Method 1 (described hereinabove), a number of epochs 1 to E may be specified. In an embodiment, at the end of each epoch, the transforming (1105) may include updating the target model

$$( e . g . , student model {ℱ}_{{θ}^{i}}^{S} )$$

based on at least one of the energy loss metric and the KD loss metric using the target model that resulted from the previous epoch

$$( e . g . , student model {ℱ}_{{θ}^{i - 1}}^{S} ) ;$$

epoch 1 may be a special case that resulted from the previous epoch model

$$( e . g . , teacher model {ℱ}_{{θ}^{*}}^{S} )$$

as the model from the previous epoch. According to another embodiment, the obtained dataset (e.g., the forget dataset D_{f}) may be divided into as many subsets (e.g., batch B′) as there are epochs E and the operations for a given iteration may be performed on the corresponding subset.

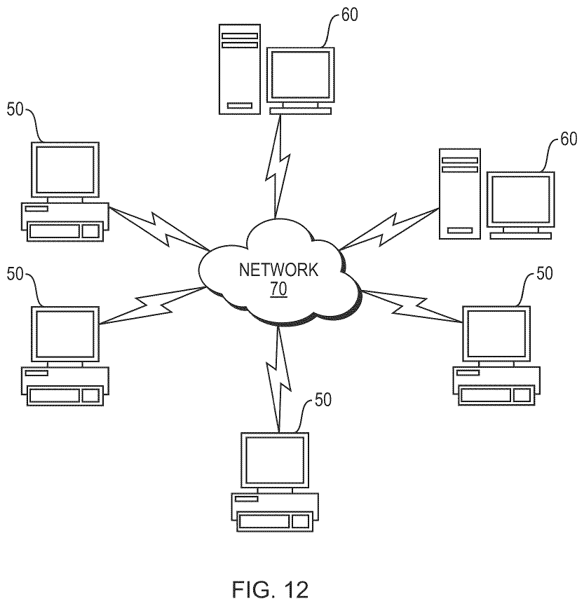

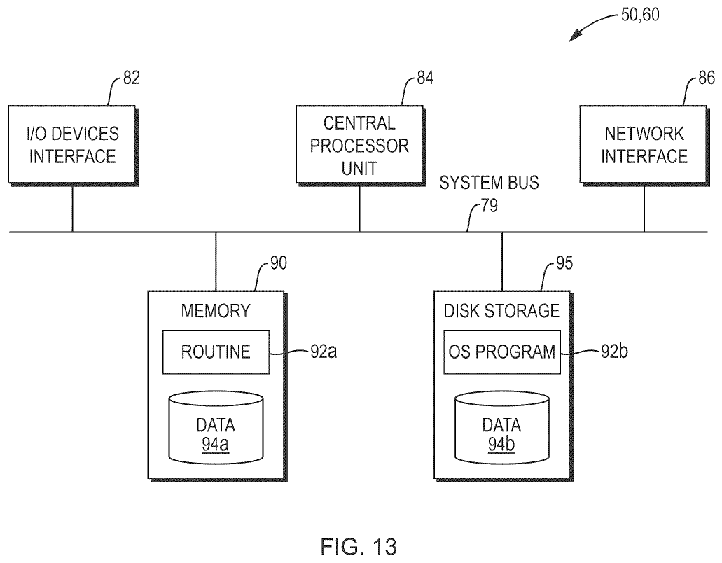

As noted, the method 1100 is computer-implemented and, as such, the functionality and effective operations, e.g., the obtaining (1101), saving (1102), using (1103), processing (1104), and transforming (1105), are automatically implemented by one or more digital processors. The method 1100 can also be implemented using any computer device or combination of computing devices known in the art. Among other examples, the method 1100 can be implemented using computer(s)/device(s) 50 and/or 60 described hereinbelow in relation to FIGS. 12 and 13.

In an example embodiment of the method 1100, processing 1104 the generated output may include determining the energy loss metric using an HFE partition function, the subset of the obtained dataset, and the generated output.

According to an example embodiment of the method 1100, using 1103 the obtained ML model to generate the output may include: (1) transforming the subset of the obtained dataset into OOD data (e.g., 112 (FIG. 1)) using a noise distribution (e.g., 108 (FIG. 1)); (2) using the obtained ML model, generating a reference output based on the OOD data; and (3) using the target model, generating a target output based on the subset of the obtained dataset. In one such embodiment, processing 1104 the generated output may include determining the KD loss metric based on the subset of the obtained dataset, the generated reference output, and the generated target output. According to another such embodiment, determining the KD loss metric may include determining KL divergence (e.g., 122 (FIG. 1)) based on the subset of the obtained dataset, the generated reference output, and the generated target output. In yet another such embodiment, the noise distribution may be a Gaussian distribution or a Bernoulli distribution.

In an example embodiment, the method 1100 may further include (1) generating a gradient mask (e.g., 102 (FIG. 1)) using the obtained ML model and the obtained dataset and (2) transforming (e.g., 126 (FIG. 1)) the target model into the unlearned ML model based on the generated gradient mask and at least one of the energy loss metric and the KD loss metric. According to one such embodiment, generating the gradient mask may include: (1) determining a cross-entropy metric using the obtained ML model and the obtained dataset; (2) determining an importance value of a parameter of the obtained ML model based on a value of the parameter and the determined cross-entropy metric; and (3) determining a mask value of the gradient mask based on comparing the determined importance value to a threshold value.

According to an example embodiment of the method 1100, transforming 1105 the target model into the unlearned ML model may include (1) determining an unlearning loss metric (e.g., 124 (FIG. 1)) based on a weighting value and both the energy loss metric and the KD loss metric and (2) transforming the target model into the unlearned ML model based on the determined unlearning loss metric.

In an example embodiment of the method 1100, transforming 1105 the target model into the unlearned ML model may include transforming the target model into the unlearned ML model based on a learning rate value and at least one of the energy loss metric and the KD loss metric.

According to an example embodiment of the method 1100, the criterion may be a number of epochs.

In an example embodiment, the method 1100 may be implemented at least in part in a mobile or edge device (e.g., 768 (FIG. 7)).

According to an example embodiment of the method 1100, the obtained ML model may be a neural network model.

In an example embodiment of the method 1100, the target class may be an outdated object class, a facial recognition class, or a malicious class.

### Example Advantages

Embodiments achieve better performance in terms of removing unwanted classes than existing approaches. For instance, an example embodiment is up to 4.74% better than conventional approaches.

Embodiments can be used in settings where access to an entire model training dataset is limited or unavailable. Whereas traditional approaches rely on access to such a dataset, embodiments can be used even when only data from a forget class is available.

Further, embodiments provide a faster and computationally less expensive way of removing information about a forget class from a ML model, e.g., a DNN. Embodiments improve energy consumption and latency compared to conventional approaches by 68% and 90%, respectively.

### Example Applications

Embodiments may be used to implement ML as a Service (MLaaS). MLaaS platforms may often require removing user data from a pretrained model, e.g., a neural network.

Further, embodiments may be used for managing medical records and removing patient information to ensure patient privacy and data security. Similarly, embodiments may be used to ensure ML models comply with privacy regulations, e.g., through the unlearning of private/classified data.

Embodiments may be used to adapt a ML model to remove malicious data after deployment at, e.g., a mobile or edge computing environment. Similarly, embodiments may be used to remove outdated or obsolete data from the deployed model.

### Computer Support

FIG. 12 is a schematic view of a computer network in which embodiments may be implemented. Client computer(s)/devices 50 and server computer(s) 60 provide processing, storage, and input/output (I/O) devices executing application programs and the like. Client computer(s)/device(s) 50 can also be linked through communications network 70 to other computing devices, including other client device(s)/processor(s) 50 and server computer(s) 60. The communications network 70 can be part of a remote access network, a global network (e.g., the Internet), cloud computing servers or service, a worldwide collection of computers, local area or wide area networks, and gateways that currently use respective protocols (e.g., TCP/IP, Bluetooth®, etc.) to communicate with one another. Other electronic device/computer network architectures are also suitable.

FIG. 13 is a block diagram illustrating an example embodiment of a computer node (e.g., client processor(s)/device(s) 50 or server computer(s) 60) in the computer network 70 of FIG. 12. Each computer node 50, 60 contains system bus 79, where a bus is a set of hardware lines used for data transfer among components of a computer or processing system. The system bus 79 is essentially a shared conduit that connects different elements of a computer system (e.g., processor, disk storage, memory, I/O ports, network ports, etc.) that enables transfer of information between the elements. Attached to the system bus 79 is an I/O devices interface 82 for connecting various input and output devices (e.g., keyboard, mouse, display(s), printer(s), speaker(s), etc.) to the computer node 50, 60. A network interface 86 allows the computer node to connect to various other devices attached to a network (e.g., the network 70 of FIG. 12). A memory 90 provides volatile storage for computer software instructions 92a and data 94a used to implement embodiments of the present disclosure (e.g., the framework 100 of FIG. 1, the experimental setup 700 of FIG. 7, the method 1100 of FIG. 11, etc.). A disk storage 95 provides non-volatile storage for the computer software instructions 92b and data 94b used to implement an embodiment of the present disclosure. A central processor unit 84 is also attached to the system bus 79 and provides for execution of computer instructions.

In an embodiment, the processor routines 92a-92b and data 94a-94b are a computer program product (generally referenced as 92), including a non-transitory, computer readable medium (e.g., a removable storage medium such as DVD-ROM(s), CD-ROM(s), diskette(s), tape(s), etc.) that provides at least a portion of the software instructions for the disclosure system. The computer program product 92 can be installed by any suitable software installation procedure, as is well known in the art. In another embodiment, at least a portion of the software instructions may also be downloaded over a cable, communication, and/or wireless connection. In other embodiments, the disclosure programs are a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present disclosure routines/program 92.

In alternative embodiments, the propagated signal is an analog carrier wave or digital signal carried on the propagated medium. For example, the propagated signal may be a digitized signal propagated over a global network (e.g., the Internet), a telecommunications network, or other networks (such as the network 70 of FIG. 12). In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of the computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium, and the like.

In other embodiments, the program product 92 may be implemented as a so-called Software as a Service (SaaS), or other installation or communication supporting end-users.

Embodiments or aspects thereof may be implemented in the form of hardware including but not limited to hardware circuitry, firmware, or software. If implemented in software, the software may be stored on any non-transient computer readable medium that is configured to enable a processor to load the software or subsets of instructions thereof. The processor then executes the instructions and is configured to operate or cause an apparatus to operate in a manner as described herein.

Further, hardware, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and, thus, the data processors described herein are intended for purposes of illustration only and not as a limitation of the embodiments.

The teachings of all patents, published applications, and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A computer-based system for unlearning, the system comprising:
at least one processor; and
a memory with computer code instructions stored thereon, the at least one processor and the memory, with the computer code instructions, configured to cause the system to:
obtain (i) a machine learning (ML) model trained on multiple classes of data and (ii) a dataset representing a target class, of the multiple classes, to be unlearned from the obtained ML model;
save an instance of the obtained ML model as a target model; and
iteratively, until a criterion is met:
use the obtained ML model to generate an output based on a subset of the obtained dataset;
process the generated output to determine at least one of an energy loss metric and a knowledge distillation (KD) loss metric; and
transform the target model into an unlearned ML model based on at least one of the energy loss metric and the KD loss metric.

2. The system of claim 1, where, in processing the generated output, the at least one processor and the memory, with the computer code instructions, are configured to cause the system to:
determine the energy loss metric using a Helmholtz free energy (HFE) partition function, the subset of the obtained dataset, and the generated output.

3. The system of claim 1, where, in using the obtained ML model to generate the output, the at least one processor and the memory, with the computer code instructions, are configured to cause the system to:
transform the subset of the obtained dataset into out-of-distribution (OOD) data using a noise distribution;
using the obtained ML model, generate a reference output based on the OOD data; and
using the target model, generate a target output based on the subset of the obtained dataset.

4. The system of claim 3, where, in processing the generated output, the at least one processor and the memory, with the computer code instructions, are configured to cause the system to:
determine the KD loss metric based on the subset of the obtained dataset, the generated reference output, and the generated target output.

5. The system of claim 4, where, in determining the KD loss metric, the at least one processor and the memory, with the computer code instructions, are configured to cause the system to:
determine Kullback-Leibler (KL) divergence based on the subset of the obtained dataset, the generated reference output, and the generated target output.

6. The system of claim 3, wherein the noise distribution is a Gaussian distribution or a Bernoulli distribution.

7. The system of claim 1, wherein the at least one processor and the memory, with the computer code instructions, are further configured to cause the system to:
generate a gradient mask using the obtained ML model and the obtained dataset; and
transform the target model into the unlearned ML model based on the generated gradient mask and at least one of the energy loss metric and the KD loss metric.

8. The system of claim 7, where, in generating the gradient mask, the at least one processor and the memory, with the computer code instructions, are configured to cause the system to:
determine a cross-entropy metric using the obtained ML model and the obtained dataset;
determine an importance value of a parameter of the obtained ML model based on a value of the parameter and the determined cross-entropy metric; and
determine a mask value of the gradient mask based on comparing the determined importance value to a threshold value.

9. The system of claim 1, where, in transforming the target model into the unlearned ML model, the at least one processor and the memory, with the computer code instructions, are configured to cause the system to:
determine an unlearning loss metric based on a weighting value and both the energy loss metric and the KD loss metric; and
transform the target model into the unlearned ML model based on the determined unlearning loss metric.

10. The system of claim 1, where, in transforming the target model into the unlearned ML model, the at least one processor and the memory, with the computer code instructions, are configured to cause the system to:
transform the target model into the unlearned ML model based on a learning rate value and at least one of the energy loss metric and the KD loss metric.

11. The system of claim 1, wherein the criterion is a number of epochs.

12. The system of claim 1, wherein the system is implemented at least in part in a mobile device.

13. The system of claim 1, wherein the obtained ML model is a neural network model.

14. The system of claim 1, wherein the target class is an outdated object class, a facial recognition class, or a malicious class.

15. A computer-implemented method of unlearning, the method comprising:
obtaining (i) a machine learning (ML) model trained on multiple classes of data and (ii) a dataset representing a target class, of the multiple classes, to be unlearned from the obtained ML model;
saving an instance of the obtained ML model as a target model; and
iteratively, until a criterion is met:
using the obtained ML model to generate an output based on a subset of the obtained dataset;
processing the generated output to determine at least one of an energy loss metric and a knowledge distillation (KD) loss metric; and
transforming the target model into an unlearned ML model based on at least one of the energy loss metric and the KD loss metric.

16. The method of claim 15, wherein processing the generated output includes:
determining the energy loss metric using a Helmholtz free energy (HFE) partition function, the subset of the obtained dataset, and the generated output.

17. The method of claim 15, wherein using the obtained ML model to generate the output includes:
transforming the subset of the obtained dataset into out-of-distribution (OOD) data using a noise distribution;
using the obtained ML model, generating a reference output based on the OOD data; and
using the target model, generating a target output based on the subset of the obtained dataset.

18. The method of claim 17, wherein processing the generated output includes:
determining the KD loss metric based on the subset of the obtained dataset, the generated reference output, and the generated target output.

19. The method of claim 15, further comprising:
generating a gradient mask using the obtained ML model and the obtained dataset; and
transforming the target model into the unlearned ML model based on the generated gradient mask and at least one of the energy loss metric and the KD loss metric.

20. A computer program product for unlearning, the computer program product comprising a non-transitory computer-readable medium with computer code instructions stored thereon, the computer code instructions being configured, when executed by a processor, to cause an apparatus associated with the processor to:
obtain (i) a machine learning (ML) model trained on multiple classes of data and (ii) a dataset representing a target class, of the multiple classes, to be unlearned from the obtained ML model;
save an instance of the obtained ML model as a target model; and
iteratively, until a criterion is met:
use the obtained ML model to generate an output based on a subset of the obtained dataset;
process the generated output to determine at least one of an energy loss metric and a knowledge distillation (KD) loss metric; and
transform the target model into an unlearned ML model based on at least one of the energy loss metric and the KD loss metric.
